(19) United States
(12) Patent Application Publication
(10) Pub. No.: US 2026/0269449 A1
(43) Pub. Date: Sep. 10, 2026

(54) Antenna Housing for Base Station Antenna and Base Station Antenna

(71) Applicant: OUTDOOR WIRELESS NETWORKS LLC, Richardson, TX (US)

(72) Inventors: Maosheng Liu, Suzhou (CN); PuLiang Tang, Suzhou (CN)

(21) Appl. No.: 19/468,189

(22) Filed: Feb. 3, 2026

(30) Foreign Application Priority Data
Feb. 4, 2025 (CN) 202520177673.8
Mar. 10, 2025 (CN) 202520409620.4

(51) Int. Cl. H01Q 1/00; H01Q 1/24; H01Q 1/42

(52) U.S. Cl. CPC H01Q 1/005; H01Q 1/246; H01Q 1/42

(57) ABSTRACT

An antenna housing for a base station antenna includes a front surface and a rear surface that are opposite and a first side surface and a second side surface that are opposite, which are connected to form an enclosing antenna housing, wherein at least one side surface of the first side surface and the second side surface has at least one side profile feature for reducing wind loads, wherein the side profile feature comprises at least one groove extending in a height direction of the antenna housing, the groove is opened in a width direction of the antenna housing towards an outer side of the at least one side surface, the groove is provided with at least one side recess at its side direction, and the side recess is opened in a thickness direction of the antenna housing towards an interior of the groove. The technical effect is that peak wind loads are reduced, and the omnidirectional wind load distribution on the base station antenna is optimized.

### RELATED APPLICATIONS

The present application claims priority from and the benefit of Chinese Utility Model Application No. 202520177673.8, filed Feb. 4, 2025, and from Chinese Utility Model Application No. 202520409620.4, filed Mar. 10, 2025, the disclosure of each of which is hereby incorporated herein by reference in full.

### FIELD OF THE INVENTION

The present application generally relates to the technical field of antennas, and more specifically relates to an antenna housing for a base station antenna and a base station antenna.

### BACKGROUND OF THE INVENTION

As the development of the wireless communication industry, communication frequency bands and standards continue to grow, and the number of base station antennas for transmitting and receiving wireless signals continues to grow. In addition, to accommodate more radio frequency elements, the sizes of antenna housings are increasing, and wind loads of antennas are accordingly increasing, thereby affecting the security of communication towers.

One parameter that affects the antenna design is the effective projected area (EPA) which is determined by calculation defined by TIA/ANSI-222-H. The effective projected area aims to predict effects of wind loads on antennas and their mounting structures, enabling designers to be capable of creating the secure design. Antenna housings are key structures to protect antenna systems from external environmental influences, and they play an important role in the effective projected area of base station antennas. Therefore, based on the market demand on the wind loads of antennas, there is an urgent need for a base station antenna for lowering wind loads.

### SUMMARY OF THE INVENTION

Therefore, the present disclosure aims to provide an antenna housing for a base station antenna and a base station antenna, through which at least one of the aforementioned technical problems present in the prior art can be solved.

According to embodiments of the present invention, an antenna housing for a base station antenna is provided, characterized in that the antenna housing has a front surface and a rear surface that are opposite and a first side surface and a second side surface that are opposite, which are connected to form an enclosing antenna housing, wherein at least one side surface of the first side surface and the second side surface has at least one side profile feature for reducing wind loads, wherein the side profile feature comprises at least one groove extending in a height direction of the antenna housing, the groove is opened towards an outer side of the at least one side surface in a width direction of the antenna housing, the groove is provided with at least one side recess at its side direction, and the side recess is opened towards an interior of the groove in a thickness direction of the antenna housing.

The technical effects that can be achieved by embodiments of the present invention include, but are not limited to: peak wind loads are reduced, and the omnidirectional wind load distribution on the base station antenna is optimized.

Advantageously, the groove comprises at least one of a dovetail groove and a T-shaped groove.

Advantageously, the groove has two step surfaces towards each other at its opening, and these two step surfaces are aligned with or staggered from each other in the width direction of the antenna housing.

Advantageously, the side profile feature further comprises at least one insert that can be fixed in the groove, the insert has an insertion part and a profile structure for reducing wind loads connected to the insertion part, and the insert is capable of being inserted into the groove with its insertion part in a form locking mode.

Advantageously, the profile structure of the insert is flush with or at least partially extends beyond the at least one side surface.

Advantageously, the insert comprises a truncated sphere formed as its profile structure and at least one support leg formed as its insertion part, and the truncated sphere has a bottom surface towards the at least one side surface and a truncated sphere surface away from the at least one side surface.

Advantageously, at least two support legs arranged successively in the thickness direction of the antenna housing are provided on the truncated sphere, and the truncated sphere extends to pass through a midline of the at least one side surface in the thickness direction of the antenna housing.

Advantageously, the profile structure of the insert comprises a plurality of columns and/or ribs arranged successively in the height direction of the antenna housing.

Advantageously, the columns comprise prisms and/or cylinders.

Advantageously, adjacent ribs are inclined relative to each other and are adjacent end to end.

Advantageously, the profile structure of the insert comprises at least one toothed part, and the toothed part extends parallel to, perpendicular to, or inclined to the height direction of the antenna housing.

Advantageously, the profile structure of the insert comprises a plurality of toothed parts arranged successively.

Advantageously, the toothed part comprises two sloped surfaces intersecting to each other; and alternatively, the toothed part comprises one inclined surface, one vertical surface and a horizontal surface for connecting both of them.

Advantageously, a plurality of inserts are arranged successively in the groove.

Advantageously, the side profile feature is provided on a front side part and/or a rear side part of the at least one side surface.

According to embodiments of the present invention, a base station antenna is also provided, characterized in that the base station antenna has an antenna housing for a base station antenna according to embodiments of the present invention, and the antenna housing is covered by a top end cover and a bottom end cover at both ends.

According to the present utility model, an antenna radome for a base station antenna is provided, characterized in that the radome has opposing front and rear surfaces and opposing first and second side surfaces, which are connected to form a surrounding radome; the first side surface and the second side surface each comprise a middle section, a front section disposed on the front side of the middle section, and a rear section disposed on the rear side of the middle section,

wherein, at least one of the first and second side surfaces has a composite side profile character for reducing wind load, the composite side profile character comprising a first side profile character disposed on the front section and a second side profile character disposed on the rear section, wherein the first side profile character and the second side profile character differ from each other.

The technical effects that can be achieved by the present utility model include, but are not limited to: peak wind loads are reduced, and the omnidirectional wind load distribution on the base station antenna is optimized.

Advantageously, the first side profile character has a first number of stepped rising surfaces, and the second side profile character comprises a second number of stepped rising surfaces different from the first number, each stepped rising surface being disposed transversely on the at least one side surface.

Advantageously, the stepped rising surfaces are each formed by protruding structures projecting from the at least one side surface, the protruding structures being formed by a thickened portion of the radome wall and/or by mutually offset wall sections of the radome and/or by attachments affixed to the radome wall.

Advantageously, one of the first and second side profile characters has a first stepped rising surface, while the other side profile character has a second stepped rising surface and a third stepped rising surface.

Advantageously, the first stepped rising surface is disposed facing toward or away from the middle section, and the second and third stepped rising surfaces are disposed oppositely.

Advantageously, the first stepped rising surface is formed by a first protruding structure extending away from the middle section, and the second and third stepped rising surfaces are formed by two opposing sides of a second protruding structure configured as ribs.

Advantageously, the first stepped rising surface is formed by a first side of a first protruding structure extending through the middle section, one of the second and third stepped rising surfaces is formed by a first side of a second protruding structure configured as ribs, and the other of the second and third stepped rising surfaces is jointly formed by a second side of the first protruding structure and a second side of the second protruding structure.

Advantageously, at least one stepped rising surface extends continuously or discontinuously over at least a partial length of the at least one side surface.

Advantageously, at least one stepped rising surface extends in a plane parallel to the width direction of the radome, or extends inclined relative to the plane of the radome's width direction, or is configured as an arc.

According to the present utility model, a base station antenna is also provided, characterized in that the base station antenna has an antenna radome for a base station antenna according to the present utility model, and the antenna radome is covered by a top end cover and a bottom end cover at both ends.

Those skilled in the art will understand the advantages of the respective examples and various other examples by reading the following detailed description of the respective examples with reference to the attached drawings listed below.

### DESCRIPTION OF THE DRAWINGS

Embodiments of the present invention are further illustrated below with reference to the attached drawings and examples, in which:

FIG. 1A is a schematic diagram showing mounting of a known base station antenna on a pole;

FIG. 1B a schematic front perspective view of the known base station antenna;

FIG. 1C is a schematic top view of the known base station antenna;

FIG. 2 is a schematic diagram of different wind load directions on a base station antenna;

FIG. 3A is a transverse cross-sectional view of an antenna housing of a base station antenna according to a first example of embodiments of the present invention;

FIG. 3B is a partially magnified view A of the antenna housing according to FIG. 3A;

FIG. 4 is a first variant of the antenna housing according to FIG. 3A;

FIG. 5 is a second variant of the antenna housing according to FIG. 3A;

FIG. 6A is a schematic perspective view of an antenna housing of a base station antenna according to a second example of embodiments of the present invention;

FIG. 6B is a partially magnified perspective view of the antenna housing according to FIG. 6A;

FIG. 6C is a partially magnified transverse cross-sectional view of the antenna housing according to FIG. 6A;

FIG. 6D is a front view of an insert of the antenna housing according to FIG. 6A;

FIG. 6E is a rear view of the insert of the antenna housing according to FIG. 6A;

FIG. 6F is a perspective view of the insert of the antenna housing according to FIG. 6A;

FIG. 6G is another perspective view of the insert of the antenna housing according to FIG. 6A;

FIG. 7A is a partially magnified perspective view of an antenna housing of a base station antenna according to a third example of embodiments of the present invention;

FIG. 7B is a partially magnified transverse cross-sectional view of the antenna housing according to FIG. 7A;

FIG. 7C is another partially magnified transverse cross-sectional view of the antenna housing according to FIG. 7A;

FIG. 8A is a partially magnified perspective view of an antenna housing of a base station antenna according to a fourth example of embodiments of the present invention;

FIG. 8B is another partially magnified perspective view of the antenna housing according to FIG. 8A;

FIG. 9A is a partially magnified perspective view of an antenna housing of a base station antenna according to a fifth example of embodiments of the present invention;

FIG. 9B is another partially magnified perspective view of the antenna housing according to FIG. 9A;

FIG. 10 is a partially magnified perspective view of an antenna housing of a base station antenna according to a sixth example of embodiments of the present invention;

FIG. 11A is a partially magnified transverse cross-sectional view of an antenna housing of a base station antenna according to a seventh example of embodiments of the present invention;

FIG. 11B is another partially magnified transverse cross-sectional view of the antenna housing according to FIG. 11A;

FIG. 11C is a partially magnified perspective view of the antenna housing according to FIG. 11A;

FIG. 11D is a partial side view of the antenna housing according to FIG. 11A;

FIG. 11E is a partial side view from another direction of the antenna housing according to FIG. 11A;

FIG. 11F is a front view of an insert of the antenna housing according to FIG. 11A;

FIG. 11G is a side view of the insert of the antenna housing according to FIG. 11A;

FIG. 11H is an end view of the insert of the antenna housing according to FIG. 11A;

FIG. 11I is a perspective view of the insert of the antenna housing according to FIG. 11A;

FIG. 12A is a variant of the antenna housing of the base station antenna according to FIG. 11A;

FIG. 12B is a partially magnified transverse cross-sectional view of the antenna housing of the base station antenna according to FIG. 12A;

FIG. 12C is a partially magnified perspective view of the antenna housing of the base station antenna according to FIG. 12A;

FIG. 12D is a partial side view of the antenna housing of the base station antenna according to FIG. 12A;

FIG. 12E is a partial side view from another direction of the antenna housing of the base station antenna according to FIG. 12A;

FIG. 13A is a partially magnified transverse cross-sectional view of an antenna housing of a base station antenna according to an eighth example of embodiments of the present invention;

FIG. 13B is another partially magnified transverse cross-sectional view of the antenna housing according to FIG. 13A;

FIG. 13C is a partially magnified perspective view of the antenna housing according to FIG. 13A;

FIG. 13D is a partial side view of the antenna housing according to FIG. 13A;

FIG. 13E is a partial side view from another direction of the antenna housing according to FIG. 13A;

FIG. 13F is a front view of an insert of the antenna housing according to FIG. 13A;

FIG. 13G is a side view of the insert of the antenna housing according to FIG. 13A;

FIG. 13H is an end view of the insert of the antenna housing according to FIG. 13A;

FIG. 13I is a perspective view of the insert of the antenna housing according to FIG. 13A;

FIG. 14A is a variant of the antenna housing of the base station antenna according to FIG. 13A;

FIG. 14B is a partially magnified transverse cross-sectional view of the antenna housing of the base station antenna according to FIG. 14A;

FIG. 14C is a partially magnified perspective view of the antenna housing of the base station antenna according to FIG. 14A;

FIG. 14D is a partial side view of the antenna housing of the base station antenna according to FIG. 14A;

FIG. 14E is a partial side view from another direction of the antenna housing of the base station antenna according to FIG. 14A;

FIG. 15A is a partially magnified transverse cross-sectional view of an antenna housing of a base station antenna according to a ninth example of embodiments of the present invention;

FIG. 15B is another partially magnified transverse cross-sectional view of the antenna housing according to FIG. 15A;

FIG. 15C is a partially magnified perspective view of the antenna housing according to FIG. 15A;

FIG. 15D is a partial side view of the antenna housing according to FIG. 15A;

FIG. 15E is a partial side view of another aspect of the antenna housing according to FIG. 15A;

FIG. 15F is a front view of an insert of the antenna housing according to FIG. 15A;

FIG. 15G is a side view of the insert of the antenna housing according to FIG. 15A;

FIG. 15H is an end view of the insert of the antenna housing according to FIG. 15A;

FIG. 15I is a perspective view of the insert of the antenna housing according to FIG. 15A;

FIG. 16A is a variant of the antenna housing of the base station antenna according to FIG. 15A;

FIG. 16B is a partially magnified transverse cross-sectional view of the antenna housing of the base station antenna according to FIG. 16A;

FIG. 16C is a partially magnified perspective view of the antenna housing of the base station antenna according to FIG. 16A;

FIG. 16D is a partial side view of the antenna housing of the base station antenna according to FIG. 16A;

FIG. 16E is a partial side view of another aspect of the antenna housing of the base station antenna according to FIG. 16A;

FIG. 17 is a comparison chart of omnidirectional wind load distribution characteristic diagrams of an existing base station antenna and the base station antenna of embodiments of the present invention;

FIG. 18 is a schematic perspective view of an antenna radome for a base station antenna according to a first example of the present utility model, along with a partial enlarged view thereof;

FIG. 19 is a partially enlarged perspective view of the antenna radome according to FIG. 18;

FIG. 20 is another partially enlarged perspective view of the antenna radome according to FIG. 18;

FIG. 21 is a partially enlarged cross-sectional view of the antenna radome according to FIG. 18, along with a partial enlarged view at a side profile feature;

FIG. 22A is a first variant of the antenna radome according to FIG. 21;

FIG. 22B is a second variant of the antenna radome according to FIG. 21;

FIG. 22C is a third variant of the antenna radome according to FIG. 21;

FIG. 22D is a fourth variant of the antenna radome according to FIG. 21;

FIG. 23 is a schematic perspective view of an antenna radome for a base station antenna according to a second example of the present utility model, along with a partial enlarged view thereof;

FIG. 24 is a partially enlarged perspective view of the antenna radome according to FIG. 23;

FIG. 25 is another partially enlarged perspective view of the antenna radome according to FIG. 23;

FIG. 26 is a partially enlarged cross-sectional view of the antenna radome according to FIG. 25, along with a partial enlarged view at a side profile feature;

FIG. 27A is a first variant of the antenna radome according to FIG. 26;

FIG. 27B is a second variant of the antenna radome according to FIG. 26;

FIG. 27C is a third variant of the antenna radome according to FIG. 26; and

FIG. 27D is a fourth variant of the antenna radome according to FIG. 26.

### DETAILED DESCRIPTION OF SPECIFIC EMBODIMENTS

Embodiments of the present invention will be described with reference to the attached drawings, in which several examples of embodiments of the present invention are illustrated. However, it should be understood that embodiments of the present invention can be presented in various different ways and is not limited to the examples described below. In fact, the examples described below aim to make the disclosure of embodiments of the present invention more complete and to fully explain the scope of protection of embodiments of the present invention to those skilled in the art. It should also be understood that the examples disclosed in the present disclosure may be combined in various ways so as to provide more additional examples.

It should be understood that in all the attached drawings, the same reference numerals of the attached drawings denote the same elements. In the attached drawings, the dimensions of certain features can be changed for clarity.

It should be understood that the terms used in the Specification are only used to describe specific examples and are not intended to limit embodiments of the present invention. Unless otherwise defined, all terms (including technical terms and scientific terms) used in the Specification have the meanings commonly understood by those of ordinary skill in the art. For brevity and/or clarity, well-known functions or structures may not be further described in detail.

The singular forms “a”, “an”, “the” and “this” used in the Specification all include plural forms unless clearly indicated. The terms “comprises,” “comprises,” and “containing” as used in the specification indicate the presence of the claimed features but do not exclude the presence of one or more other features. The term “and/or” as used in the specification comprises any and all combinations of one or more of the related listed items. The words “between X and Y” and “between approximate X and Y” used in the Specification shall be interpreted as including X and Y. As used herein, the wording “between about X and Y” means “between approximate X and approximate Y”, and as used herein, the wording “from X to Y” means “from approximate X to approximate Y”.

In the Specifications, when it is described that an element is “on” another element, “attached” to another element, “connected” to another element, “coupled” with another element, or “in contact with” another element, etc., the element may be directly on another element, attached to another element, connected to another element, coupled with another element, or in contact with another element, or an intermediate element may be present. In contrast, if an element is described as “directly” “on” another element, “directly attached” to another element, “directly connected” to another element, “directly coupled” to another element, or “directly in contact with” another element, no intermediate elements are present. In the Specification, a feature that is arranged “adjacent” to another feature, may denote that a feature has a part that overlaps an adjacent feature or a part located above or below the adjacent feature.

In the Specification, words expressing spatial relations such as “upper”, “lower”, “left”, “right”, “front”, “rear”, “top”, and “bottom” may describe the relation between one feature and another feature in the attached drawings. It should be understood that spatial relationship terms include not only the orientation shown in the attached drawings but also different orientations of the device in use or operation. For example, when the device in the attached drawings is inverted, a feature originally described as “below” another feature may then be described as “above” the other feature. The apparatus may also be oriented in other ways (rotated 90 degrees or in other orientations), and the relative spatial relationships will be interpreted accordingly in those cases.

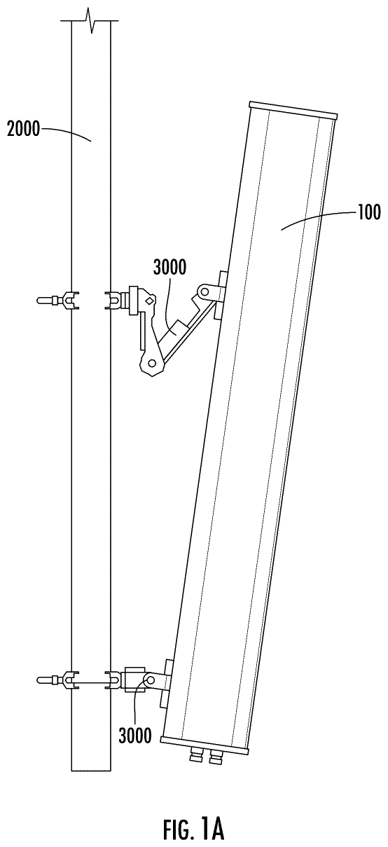

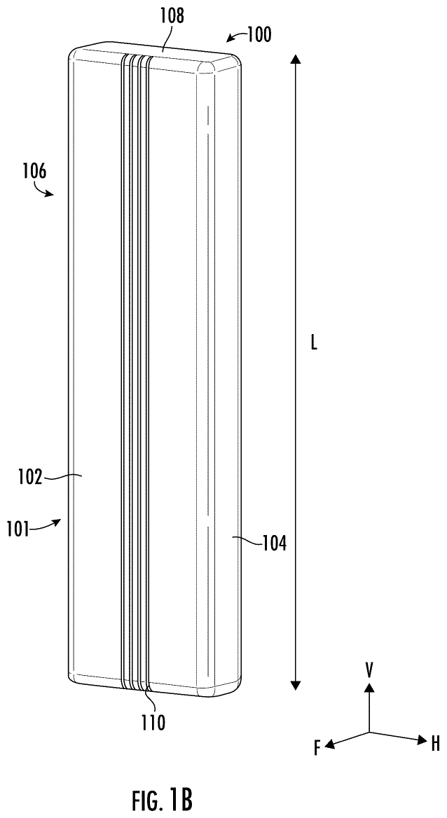

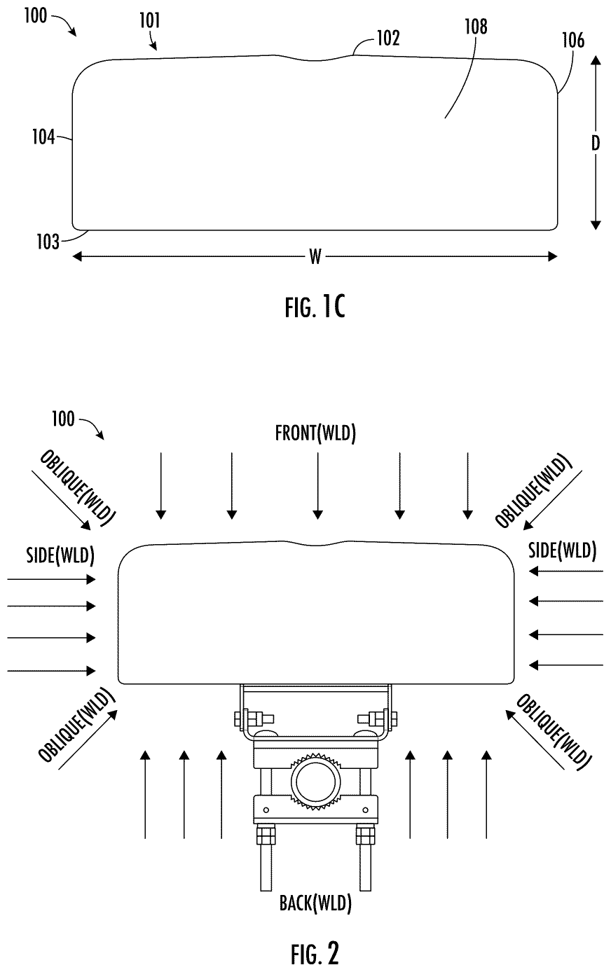

FIG. 1A shows a fixed mounting state of a known base station antenna 100 on a pole 2000, i.e., the base station antenna 100 may be fixed on the pole 2000 via two fixing devices 3000 arranged up and down.

The base station antenna 100 is typically mounted in a vertical manner. Referring to FIG. 1B, when the base station antenna 100 is in normal operation, a longitudinal direction or vertical direction V may be substantially perpendicular to a plane defined by a horizon line. The longitudinal direction V of the base station antenna 100 may be perpendicular to a horizontal direction H and a forward direction F, and a radiating element array mounted within the base station antenna 100 may extend forward along the forward direction F from a reflector.

The base station antenna 100 is generally elongated, is covered by an antenna housing 101 comprising a front surface 102, a rear surface 103, a first side surface 104, and a second side surface 106, and is also covered by a top end cover 108 and a bottom end cover 110. In some instances, the antenna housing 101 and the end covers 108, 110 may comprise single unitary components; while in other examples, the antenna housing 101 and the end covers 108, 110 may comprise separate parts, and the end covers 108, 110 may be mounted on the antenna housing 101. The base station antenna 100 or its antenna housing 101 may have a height or height direction L, a width or width direction W, and a thickness or thickness direction D (see FIG. 1B and FIG. 1C).

An inner cavity is defined by the antenna housing 101 and two end covers 108, 110, an interior antenna component (for example, a radiating element, a reflector, a phase mover, a duplexer, a remote electronic tilt actuator, a cable, a controller, etc.) that enables the base station antenna 100 to be capable of transmitting and receiving radio frequency (RF) signals may be contained in the inner cavity. Exemplary antenna components are described, for example, in PCT Publication No. WO2017/165512A1, the disclosure of which is incorporated herein by reference. The base station antenna 100 also comprises a connector (not shown in figures), the connector enables the base station antenna 100 to be capable of connecting with one or more radio devices for transmitting and receiving RF signals, as well as connecting with other associated telecommunication devices.

The base station antenna 100 is generally mounted well above the ground for optimizing transmission. Therefore, the base station antenna 100 has a significant contribution to overall wind loads on communication towers. For example, as shown in FIG. 2, the base station antenna 100 may experience high wind loads from any direction (i.e., front, rear, and/or side directions and/or other oblique wind load directions WLD at a certain angle). Accordingly, design features of the base station antenna 100, and in particular, design features of the antenna housing 101 may affect the overall wind loads experienced by the base station antenna 100. It may be critical to reduce the wind loads on the base station antenna 100.

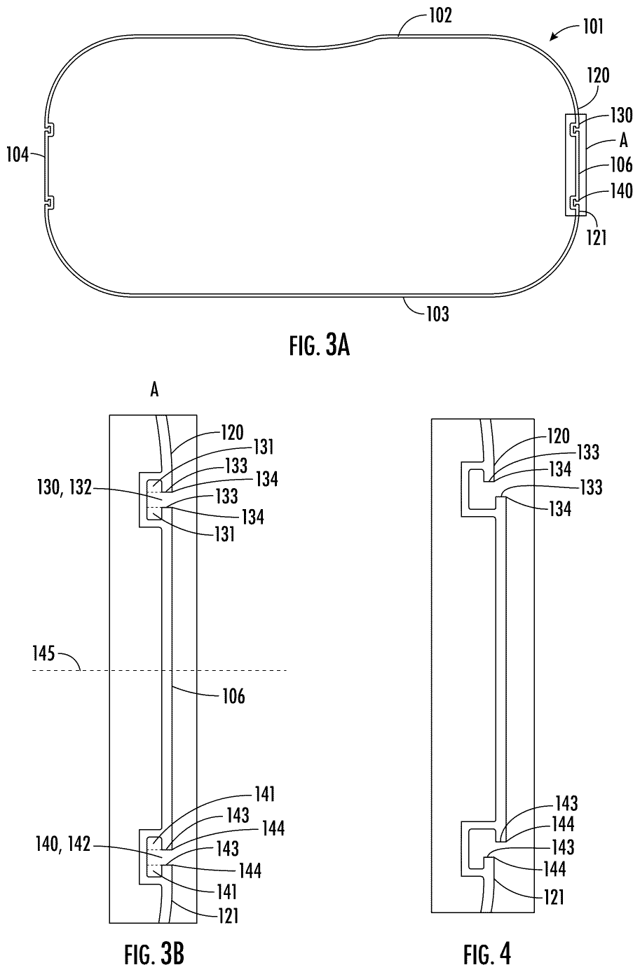

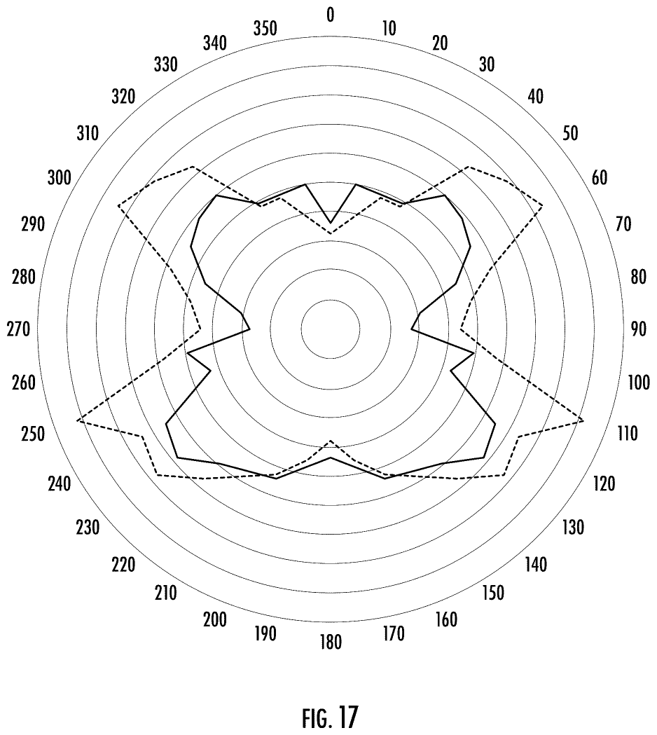

Moreover, it may be important to manage the wind loads at all different wind attack angles on the base station antenna 100. That is, it is worth pursuing: the realization of the optimized omnidirectional wind load distribution on the base station antenna 100. Referring to FIG. 17, it can be seen from the omnidirectional wind load distribution for the existing base station antenna 100 represented by a red line that four peak wind loads or high wind load regions may be located between 30° and 70° (e.g., near 50°), between 100° and 140° (e.g., near 110°), between 220° and 260° (e.g., near 250°), and between 290° and 330° (e.g., near 300°). They may be primarily formed by wind loads in the oblique wind load direction WLD. Research has found that these four peak wind loads are closely associated with profile features on the front side part 120 and the rear side part 121 of each of the first side surface 104 and the second side surface 106 of the antenna housing 101 (e.g., see FIG. 3A). The front side part 120 and the rear side part 121 may be on a front side and a rear side of a midline of each of the side surfaces 104, 106, respectively, for example, may get close to front and rear corners transitioning to the front surface 102 and the rear surface 103, respectively.

According to various examples of embodiments of the present invention, several side profile features of the antenna housing are provided, which may assist in managing the optimized omnidirectional wind load distribution on the base station antenna 100. Here, by providing the side profile features on the first side surface 104 and the second side surface 106 to form interference structures on the front side part 120 and the rear side part 121 near the corners, for example, the above-described peak wind loads can be effectively reduced. This can be seen through the optimized omnidirectional wind load distribution represented by a black line in FIG. 17. The omnidirectional wind load distribution may be further optimized by reducing the four local peak wind loads, such that some worst-case points are improved.

It will be understood that various side profile features presented in different examples may be flexibly combined and adjusted according to demands, and be not limited to the specific examples described below.

Some implementations of embodiments of the present invention will now be described in more detail with reference to the attached drawings.

Referring to FIG. 3A and FIG. 3B, an antenna housing 101 of a base station antenna 100 for reducing wind loads according to a first example of embodiments of the present invention is shown. A combination of side profile features respectively designed for reducing the wind loads on the first side surface 104 and the second side surface 106 of the antenna housing 101 can be seen here. With particular reference to FIG. 3B, the combination of side profile features on the second side surface 106 may comprise a first groove 130 provided on the front side part 120 of the second side surface 106, and the first groove 130 is formed as a first side profile feature here. The first groove 130 is opened towards an outer side of the second side surface 106 along a width direction W of the antenna housing 101. When seen on a cross section, the first groove 130 has two rectangular side recesses 131 (their openings are indicated by dashed lines) that are both towards an interior of the groove in the thickness direction D of the antenna housing 101 and opened towards each other, as well as a rectangular groove opening 132 connected to the outside of the antenna housing 101. Therefore, the first groove 130 may form a T-shaped groove, wherein the two rectangular side recesses 131 form two sides of a head of the T-shaped groove, and the rectangular groove opening 132 forms a leg of the T-shaped groove. The leg of the T-shaped groove or rather the rectangular groove opening 132 passes through a wall segment of the antenna housing 101 and thus forms two mutually parallel step surfaces 133, the two step surfaces 133 may be oriented transverse to and perpendicular to the second side surface 106 here, and these two step surfaces 133 intersect the second side surface 106, respectively, at two top edges 134. In the example shown in FIG. 3B, the two step surfaces 133 and the two top edges 134 of the first groove 130 are oppose to each other in the width direction W of the antenna housing 101 and are not staggered. The T-shaped groove on the front side part 120 of the second side surface 106, along with the two step surfaces 133 and the two top edges 134, may be seen in the omnidirectional wind load distribution to reduce a peak wind load in the range between 100° and 140° (e.g., near 110°) (see FIG. 17).

The combination of side profile features on the second side surface 106 may further comprise a second groove 140 provided on a rear side part 121 of the second side surface 106, and the second groove 140 is formed as a second side profile feature. The second groove 140 and the first groove 130 may be configured identically, or configured in a mirrored and fully-equal mode with respect to an intermediate plane 145 therebetween, and the intermediate plane 145 may pass through a midline of the second side surface 106 and be oriented perpendicular to the second side surface 106. Therefore, the second groove 140 may likewise form a T-shaped groove, the two rectangular side recesses 141 form two sides of a head of the T-shaped groove, and the rectangular groove opening 142 forms a leg of the T-shaped groove. The leg of the T-shaped groove or rather the rectangular groove opening 142 passes through a wall segment of the antenna housing 101 and thus forms two mutually parallel step surfaces 143, the two step surfaces 143 may be oriented transverse to and perpendicular to the second side surface 106 here, and these two step surfaces 143 intersect the second side surface 106, respectively, at two top edges 144. In the example shown in FIG. 3B, the two step surfaces 143 and the two top edges 144 of the second groove 140 are oppose to each other and are not staggered in the width direction W of the antenna housing 101. Referring to FIG. 17, the second groove 140 on the second side surface 106, along with the two step surfaces 143 and the two top edges 144 formed therefrom, may significantly reduce the peak wind load in the range between 30° and 70° (e.g., near 50°) in the omnidirectional wind load distribution of the base station antenna 100 (reduced from what is shown by a red line to what is shown by a black line).

In some implementations, the two side profile features (for example, the first grooves 130, 140 here) on the second side surface 106 may extend continuously over an entire length L of the antenna housing 101. In some implementations, the two side profile features may extend continuously over a local length of the antenna housing 101. In some implementations, the two side profile features may extend intermittently over the entire length L or the local length of the antenna housing 101, i.e., a plurality of side profile features are provided successively in the height direction L. The two side profile features and a main body of the antenna housing 101 may be integrally molded through a plastic extrusion molding mode. However, it is also conceivable that the two side profile features are made in separate steps, and these two side profile features made separately may be attached (e.g., bonded) to the main body of the antenna housing 101.

Furthermore, the combination of side profile features on the first side surface 104 may be provided with reference to the combination of side profile features on the second side surface 106 to reduce the peak wind loads in the ranges between 220° and 260° (e.g., near 250°) and between 290° and 330° (e.g., near 300°) (reduced from what is shown by a red line to what is shown by a black line). In some implementations, the combination of side profile features on the first side surface 104 may be designed to be symmetrical to the combination of side profile features on the second side surface 106 about a longitudinal profile parallel to the side surfaces. In some implementations, the side profile features may also be provided on the midline of the side surface to reduce the wind loads.

In the first variant of the antenna housing according to FIG. 3A and FIG. 3B shown in FIG. 4, the two step surfaces 133 and the two top edges 134 of the first groove 130 are provided in a mode of staggering from each other, and the two step surfaces 143 and the two top edges 144 of the second groove 140 are also provided in a mode of staggering from each other. This can be achieved, for example, by the following mode: arranging a wall section of the second side surface 106 that is located between the first groove 130 and the second groove 140 to be staggered outwards or to be higher than wall sections of the second side surface 106 that are located in front of the first groove 130 and behind the second groove 140.

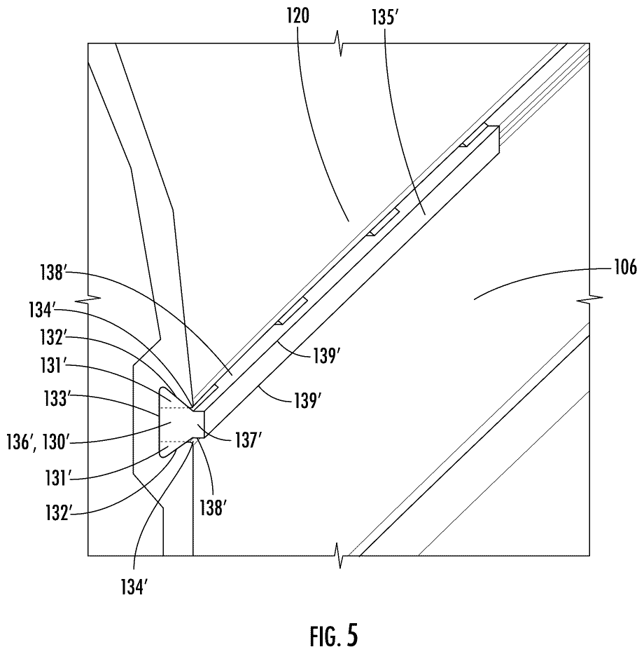

In the second variant of the antenna housing according to FIG. 3A and FIG. 3B shown in FIG. 5, using the first side profile feature of the front side part 120 on the second side surface 106 as an example, a first groove 130′ configured as a dovetail groove can be used instead of the first groove 130 configured as the T-shaped groove. The dovetail groove has two triangular side recesses 131′ (their openings are indicated by dashed lines) that are opened towards each other in the thickness direction D. Each triangular side recess 131′ has an inclined step surface 132′, and the two inclined step surfaces 132′ are connected by a bottom surface 133′ that is parallel to the second side surface 106. The two inclined step surfaces 132′ intersect with the second side surface 106, respectively, and thus form two top edges 134′, respectively. Therefore, the dovetail groove, along with the inclined step surfaces 132′ and the top edges 134′, can be seen to reduce the peak wind load in the range between 100° and 140° (e.g., near 110°) in the omnidirectional wind load distribution.

In some implementations, as also shown in FIG. 5, an insert 135′ may also be provided in the first groove 130'. The insert 135′ has an insertion part 136′ in a shape of a dovetail groove and a profile structure 137′ connected to the insertion part 136′. The insertion part 136′ of the insert 135′ is inserted in the first groove 130′ in a form locking mode, while the profile structure 137′ of the insert 135′ protrudes in the side direction from the first groove 130′ out of the second side surface 106. The profile structure 137′ can be configured as a rectangular strip, and the profile structure 137′ has two step surfaces 138′ and two top edges 139'. The profile structure 137′ on the front side part 120 of the second side surface 106, along with two step surfaces 138′ and two top edges 139′ formed therefrom, can significantly reduce the peak wind load in the range between 100° and 140° (e.g., near 110°) in the omnidirectional wind load distribution of the base station antenna 100 (reduced from what is shown by a red line to what is shown by a black line).

The length of the insert 135′ is less than that of the first groove 130′ here. Therefore a plurality of inserts 135′ can be provided in the first groove 130′ in a mode of being in contact with each other successively or being spaced apart from each other. It is also conceivable to provide the same or similar side profile features for the rear side part 121 on the second side surface 106 and for the first side surface 104.

In all the examples described below, whenever reference is made to the T-shaped groove, it is possible to be replaced with a dovetail groove or other forms of grooves with side recesses, and it is conceivable that an insertion part of the insert is correspondingly modified to be in form locking connection with the recesses.

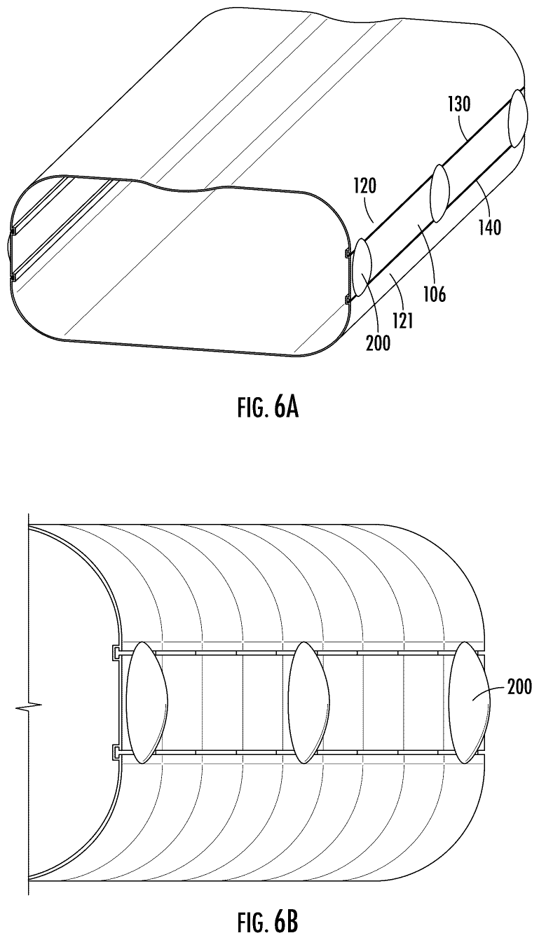

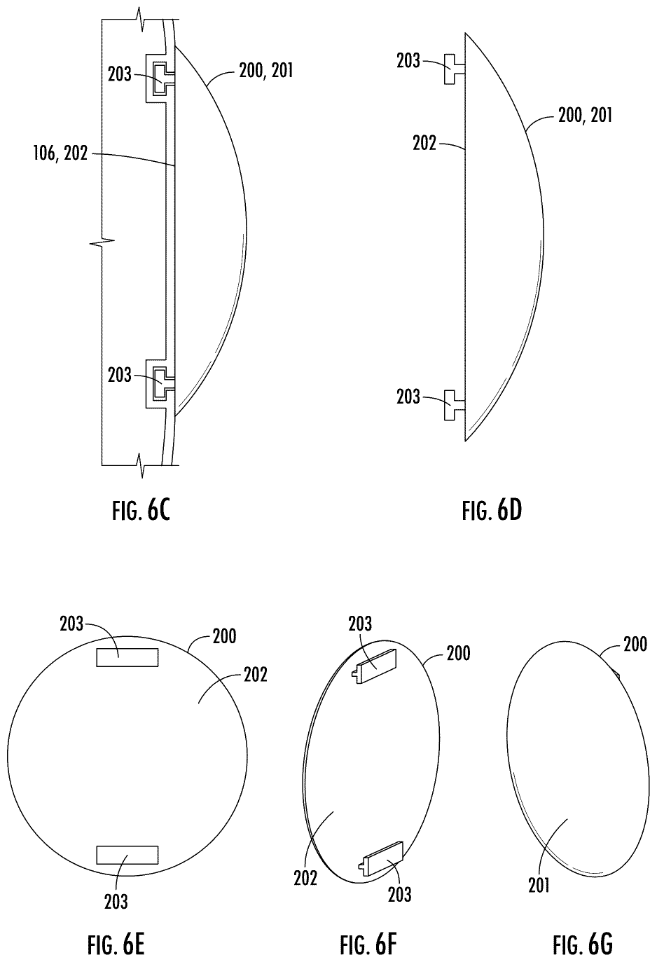

FIG. 6A to FIG. 6G show an antenna housing 101 of a base station antenna 100 according to a second example of embodiments of the present invention. With reference to FIG. 6A to FIG. 6C, by taking the second side surface 106 as an example, in addition to T-shaped grooves 130, 140 shown in FIG. 3A and FIG. 3B, a plurality of inserts 200 are further provided on the second side surface 106. These inserts 200 reduce the peak wind load in the omnidirectional wind load distribution in addition to T-shaped grooves 130, 140 shown in FIG. 3A and FIG. 3B. With reference to FIG. 6D to FIG. 6G, the profile structure of the insert 200 exposed out of the second side surface 106 is configured as a truncated sphere, thus having a dome-shaped truncated sphere surface 201 and a planar bottom surface 202. There are two T-shaped support legs 203 parallel to each other on the planar bottom surface 202, and the two T-shaped support legs 203 are inserted into respective T-shaped grooves 130, 140 on the second side surface 106 as insertion parts in a form locking mode, respectively, such that the planar bottom surface 202 of the insert 200 is attached to the second side surface 106, and the truncated sphere surface 201 of the insert 200 is exposed outwards. Referring to FIG. 6A, the profile structure in a shape of a truncated sphere of each insert 200 may extend from the front side part 120 through the midline of the side surface to the rear side part 121. Therefore, a surface structural abrupt change caused by the truncated sphere surface 201 at the front side part 120 can significantly reduce the peak wind load in the range between 100° and 140° (e.g., near 110°) in the omnidirectional wind load distribution of the base station antenna 100 (reduced from what is shown by a red line to what is shown by a black line). Similarly, a surface structural abrupt change caused by the truncated sphere surface 201 at the rear side part 121 can additionally significantly reduce the peak wind load in the range between 30° and 70° (e.g., near 50°) in the omnidirectional wind load distribution of the base station antenna 100 (reduced from what is shown by a red line to what is shown by a black line). In the example shown in FIG. 6A and FIG. 6B, only three inserts 200 are shown on the second side surface 106. However, it is conceivable to provide any suitable number of inserts 200 according to actual requirements.

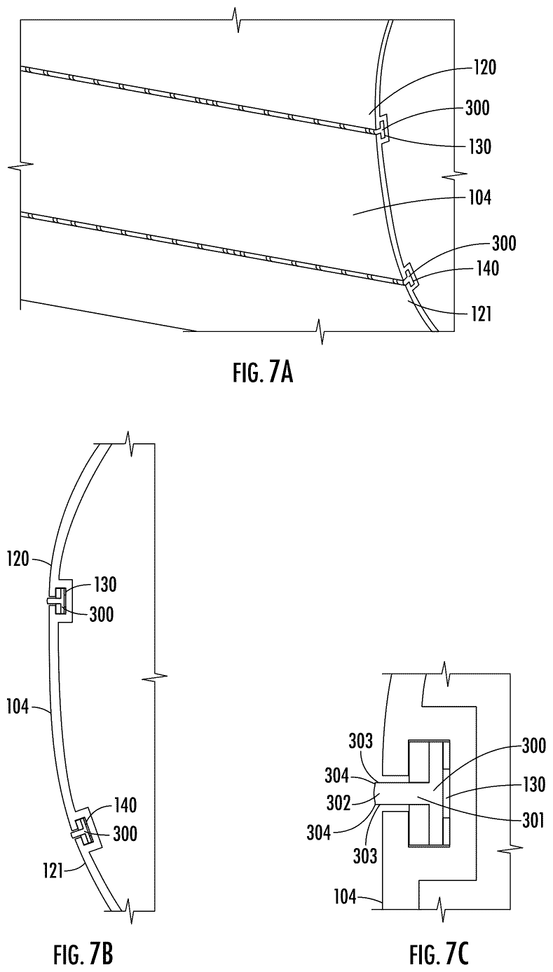

FIG. 7A to FIG. 7C show an antenna housing 101 of a base station antenna 100 according to a third example of embodiments of the present invention. Referring to FIG. 7A to FIG. 7C, the T-shaped grooves 130, 140 shown in FIG. 3A and FIG. 3B are also provided on the front side part 120 and the rear side part 121 of the first side surface 104. In addition, inserts 300 are provided in the T-shaped grooves 130, 140, and these inserts 300 affect or reduce peak wind loads in the omnidirectional wind load distribution. The T-shaped groove 130 and the insert 300 together form the side profile feature. Referring to FIG. 7C, the insert 300 is generally configured to be T-shaped in a cross section and has a T-shaped insertion part 301 inserted into the T-shaped groove 130 in a form locking mode and a profile structure 302 provided on the T-shaped insertion part 301. The T-shaped insertion part 301 is fitted to the T-shaped groove 130 in shape, i.e., the T-shaped insertion part 301 of the insert 300 can be inserted into the T-shaped groove 130 in a form locking mode. The profile structure 302 protrudes from the T-shaped grooves 130, 140, such that the profile structure 302 is higher than the first side surface 104. The profile structure 302 is generally configured here as being integral with the leg of the T-shaped insertion part 301, or as an extension of the leg, and is formed as a rectangular strip; and it therefore has two step surfaces 303 and two top edges 304. Referring to FIG. 7A, there are a plurality of rectangular strips provided successively in the height direction L of the antenna housing. They may be provided on the same insert 300, or they may be provided on a plurality of inserts 300 arranged successively, and one or more rectangular strips are provided on each insert 300. The profile structure 302 on the front side part 120 of the first side surface 104, along with two step surfaces 303 and two top edges 304 formed therefrom, can significantly reduce the peak wind load in the range between 220° and 260° (e.g., near 250°) in the omnidirectional wind load distribution of the base station antenna 100 (reduced from what is shown by a red line to what is shown by a black line). The second side profile feature on the rear side part 121 may be provided the same as the first side profile feature on the front side part 120. The first side profile feature and the second side profile feature may be symmetrically formed with respect to the intermediate plane perpendicular to the first side surface 104. The second side profile feature can be seen to reduce the peak wind load in the range between 290° and 330° (e.g., near 300°) in the omnidirectional wind load distribution.

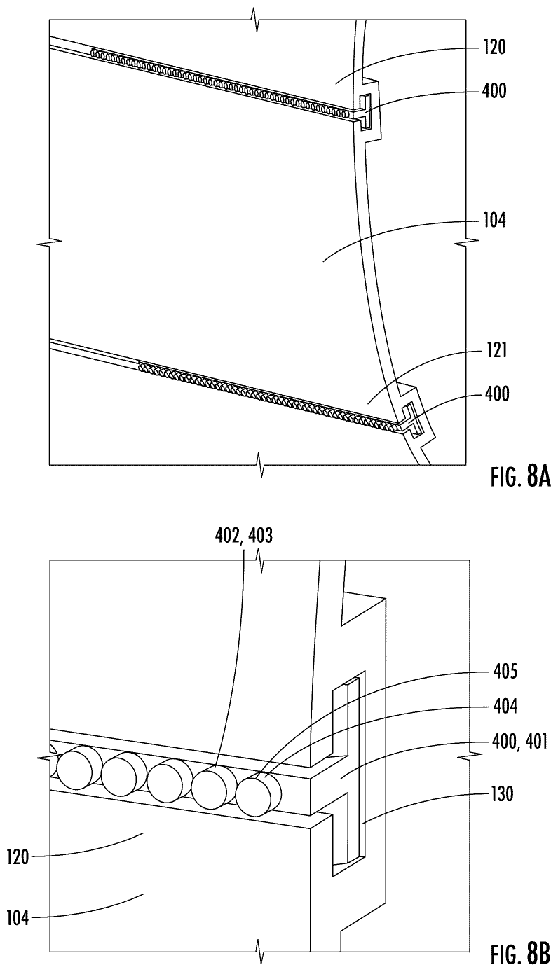

FIG. 8A to FIG. 8B show an antenna housing 101 of a base station antenna 100 according to a fourth example of embodiments of the present invention. The fourth example may differ from the third example shown in FIG. 7A to FIG. 7C only in the design of the profile structure of the insert. Taking the first side profile feature on the front side part 120 on the first side surface 104 as an example, the profile structure 402 of the insert 400 of the fourth example is configured as a plurality of cylinders 403 arranged successively in the height direction L of the antenna housing and connected to the T-shaped insertion part 401. These cylinders 403, as the profile structure 402, can protrude in the side direction from the first groove 130 and thus protrude out of the first side surface 104. Therefore, cylindrical surfaces 404 of these cylinders 403 and end edges 405 of these cylinders 403 can significantly reduce the peak wind load in the omnidirectional wind load distribution of the base station antenna 100. Other aspects of the antenna housing 101 of the base station antenna 100 according to the fourth example adaptively refer to the design or variant of the antenna housing 101 according to the third example, and are not repeated here.

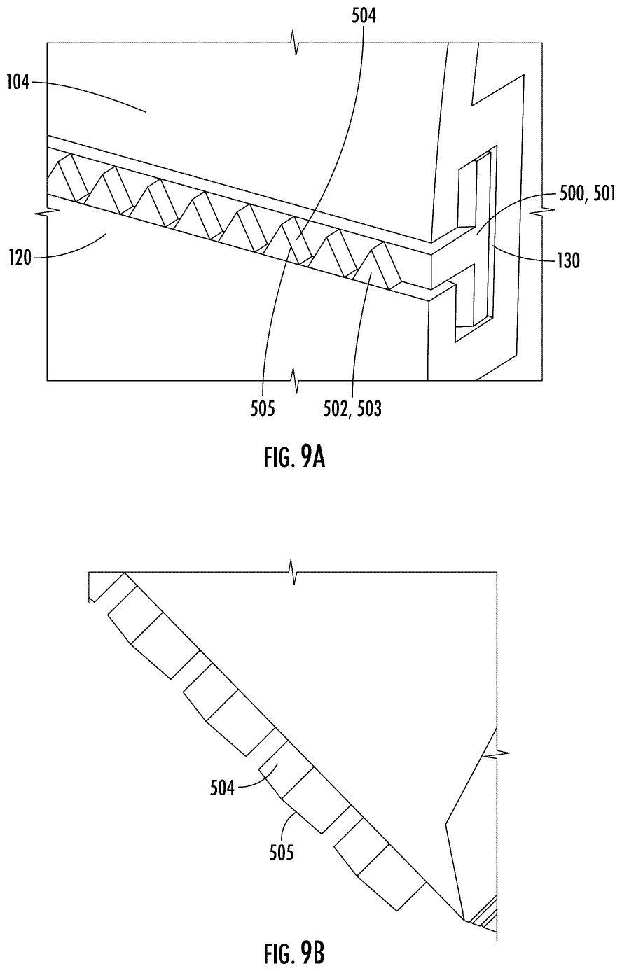

FIG. 9A to FIG. 9B show an antenna housing 101 of a base station antenna 100 according to a fifth example of embodiments of the present invention. This fifth example may differ from the third example and the fourth example only in the design of the profile structure of the insert. Taking the first side profile feature on the front side part 120 on the first side surface 104 as an example, the profile structure 502 of the insert 500 of the fifth example is configured as a plurality of regular triangular prisms 503 arranged successively in the height direction L of the antenna housing and connected to the T-shaped insertion part 501. These regular triangular prisms 503, as the profile structure 502, can protrude in the side direction from the first groove 130 out of the first side surface 104. Therefore, three prism surfaces 504 of these regular triangular prisms 503 and end edges 505 of these regular triangular prisms 503 can significantly reduce the peak wind load in the omnidirectional wind load distribution of the base station antenna 100. Other aspects of the antenna housing 101 of the base station antenna 100 according to the fifth example adaptively refer to the design or variant of the antenna housing 101 according to the third example and are not repeated here.

FIG. 10 shows an antenna housing 101 of a base station antenna 100 according to a sixth example of embodiments of the present invention. The sixth example may differ from the third example, the fourth example, and the fifth example only in the design of the profile structure of the insert. Taking the first side profile feature on the front side part 120 on the first side surface 104 as an example, the profile structure 602 of the insert 600 of the sixth example is configured as a plurality of regular quadrilateral prisms 603 arranged successively in the height direction L of the antenna housing and connected to the T-shaped insertion part 601. These regular quadrilateral prisms 603, as the profile structure 602, can protrude in the side direction from the first groove 130 out of the first side surface 104. Therefore, four prism surfaces 604 of these regular quadrilateral prisms 603 and end edges 605 of these regular quadrilateral prisms 603 can significantly reduce the peak wind load in the omnidirectional wind load distribution of the base station antenna 100. Other aspects of the antenna housing 101 of the base station antenna 100 according to the sixth example adaptively refer to the design or variant of the antenna housing 101 according to the third example and are not repeated here.

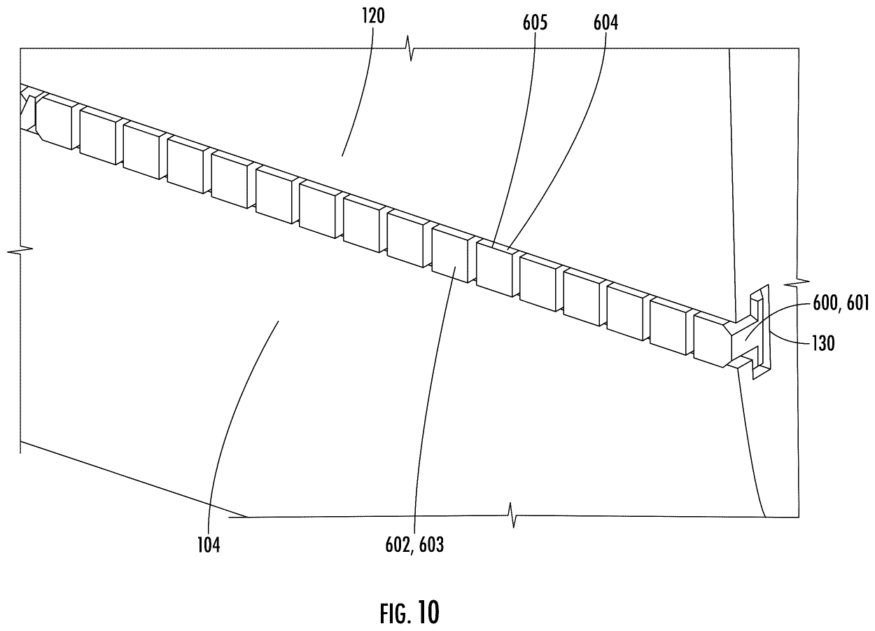

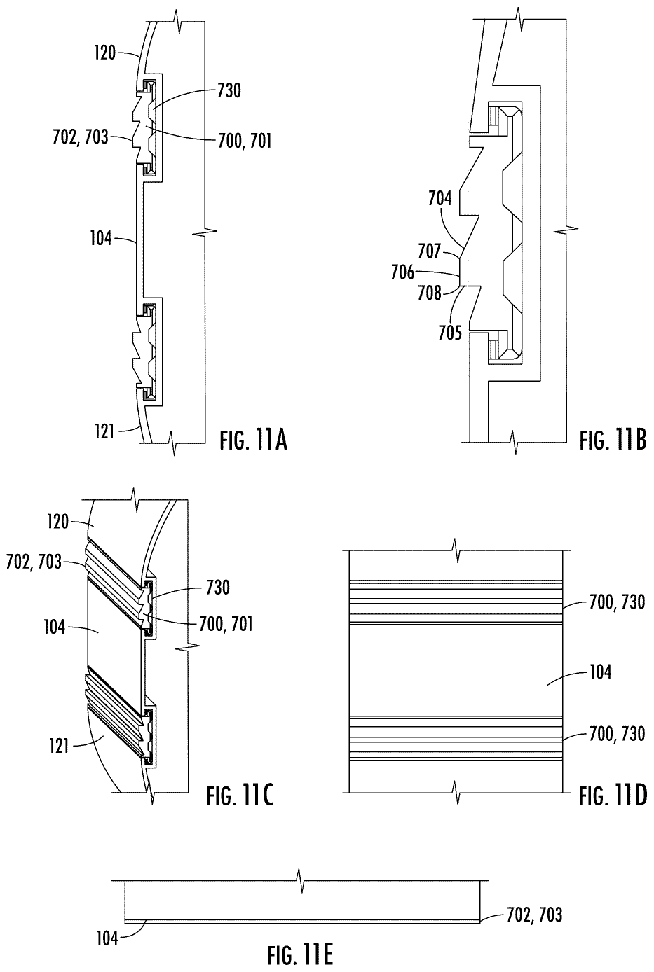

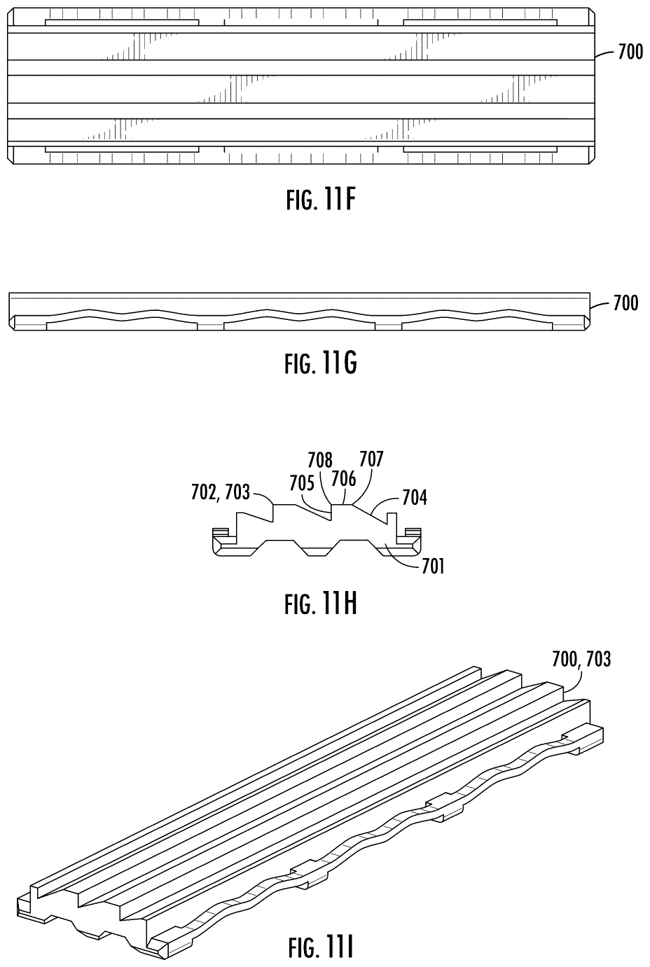

FIG. 11A to FIG. 11I show an antenna housing 101 of a base station antenna 100 according to a seventh example of embodiments of the present invention. A combination of side profile features provided for reducing the wind loads are provided on the first side surface 104 of the exemplary visible antenna housing 101 here. In particular, referring to FIG. 11A, the first side profile feature on the front side part 120 is described as an example, which may comprise a wider T-shaped groove 730 provided on the front side part 120 of the first side surface 104, and the first side profile feature may also comprise a T-shaped insert 700 that will be shown in greater detail in FIG. 11F to FIG. 11I, which may be inserted into the T-shaped groove 730. Referring to FIG. 11F to FIG. 11I, the T-shaped insert 700 has an insertion part 701 and a profile structure 702 provided on the insertion part 701. The profile structure 702 is configured to be in a shape of a washboard, and has a plurality of toothed parts 703 extending parallel to the height direction L of the antenna housing 101. In particular, with reference to the side views shown in FIG. 11B and FIG. 11E, the toothed parts 703 at least partially protrude out the first side surface 104 in the T-shaped groove 730 here. Each toothed part 703 has a step surface 704 that is inclined to the first side surface 104, a step surface 705 that is perpendicular to the first side surface 104, and a horizontal surface 706 that connects the step surface 704 with the step surface 705. The step surface 704 and the step surface 705 intersect the horizontal surface 706, respectively, thereby forming a top edge 707 and a top edge 708. The step surface 704 and the step surface 705, as well as the top edge 707 and the top edge 708, can be seen to reduce the peak wind load in the range of 220° to 260° (e.g., near 250°) in the omnidirectional wind load distribution.

Referring to FIG. 11A, the combination of side profile features may comprise a second side profile feature provided on a rear side part 121 of the first side surface 104. The first side profile feature and the second side profile feature may be arranged identically to each other and may be symmetrically formed in a mirrored mode about the intermediate plane perpendicular to the first side surface 104. The second side profile feature of the first side surface 104 can be seen to reduce the peak wind load in the range between 290° and 330° (e.g., near 300°) in the omnidirectional wind load distribution.

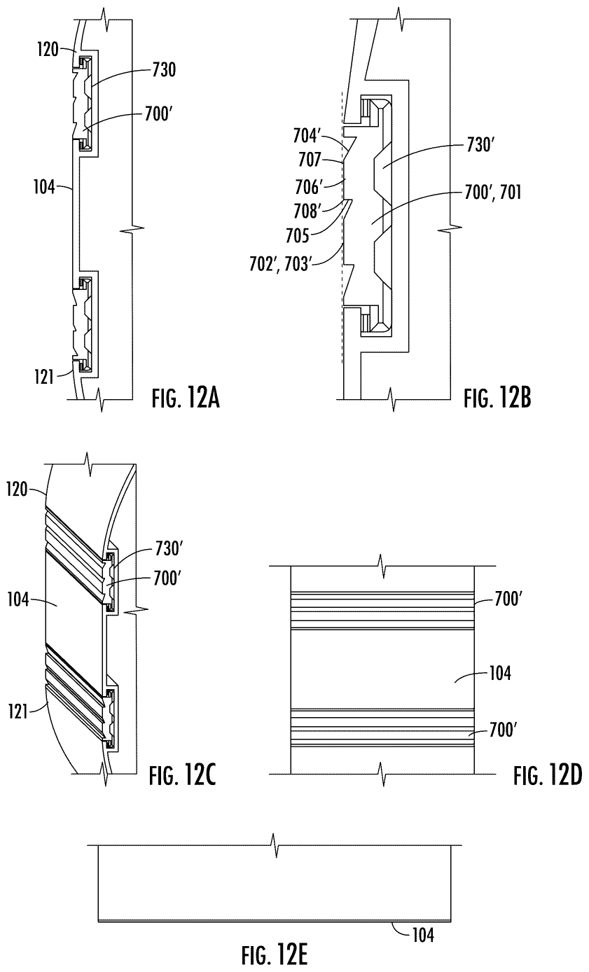

FIG. 12A to FIG. 12E show a variant of an antenna housing 101 of a base station antenna 100 according to the seventh example. The seventh example is substantially the same as the sixth example, but the difference is that, particularly referring to the side views shown in FIG. 12B and FIG. 12E, the toothed part 703′ of the profile structure 702′ on the insertion part 701′ of the insert 700′ does not extend outwards beyond the T-shaped groove 730′ or the first side surface 104. In other words, the horizontal surface 706′ of the toothed part 703′ does not protrude beyond the first side surface 104. Referring to FIG. 12B, the horizontal surface 706′ is flush with the first side surface 104. However, as in the sixth example, the step surface 704′ and the step surface 705', as well as the top edge 707′ and the top edge 708', can still be seen to reduce the peak wind load in the omnidirectional wind load distribution.

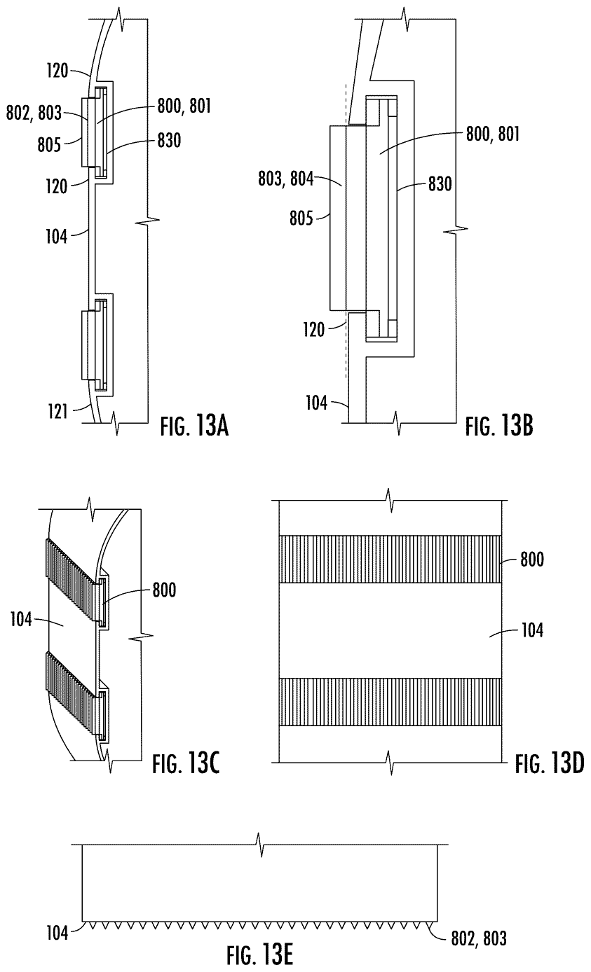

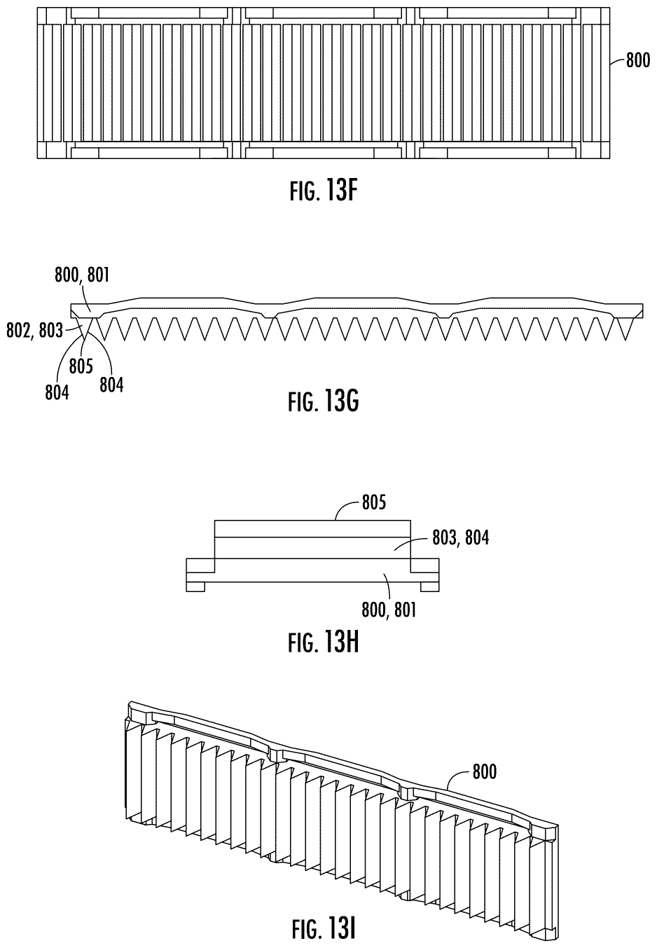

FIG. 13A to FIG. 13I show an antenna housing 101 of a base station antenna 100 according to an eighth example of embodiments of the present invention. The difference from the antenna housing 101 of the base station antenna 100 according to the seventh example is the different profile structure 802 of the T-shaped insert 800 connected to the insertion part 801. In the eighth example, the profile structure 802 is also configured to be in a shape of a washboard, but has a plurality of toothed parts 803 extending perpendicular to the height direction L of the antenna housing 101. Each toothed part 803 has two sloped surfaces 804 extending inclined to the first side surface 104, and the two sloped surfaces 804 intersect at the top edge 805. Each toothed part 803 here at least partially extends beyond the outer surface of the first side surface 104 (see, in particular, FIG. 13B). The two sloped surfaces 804 and the top edge 805 can be seen to reduce the peak wind load in the omnidirectional wind load distribution. Other aspects of the antenna housing 101 of the base station antenna 100 according to the eighth example adaptively refer to the design or variant of the antenna housing 101 according to the seventh example and are not repeated here.

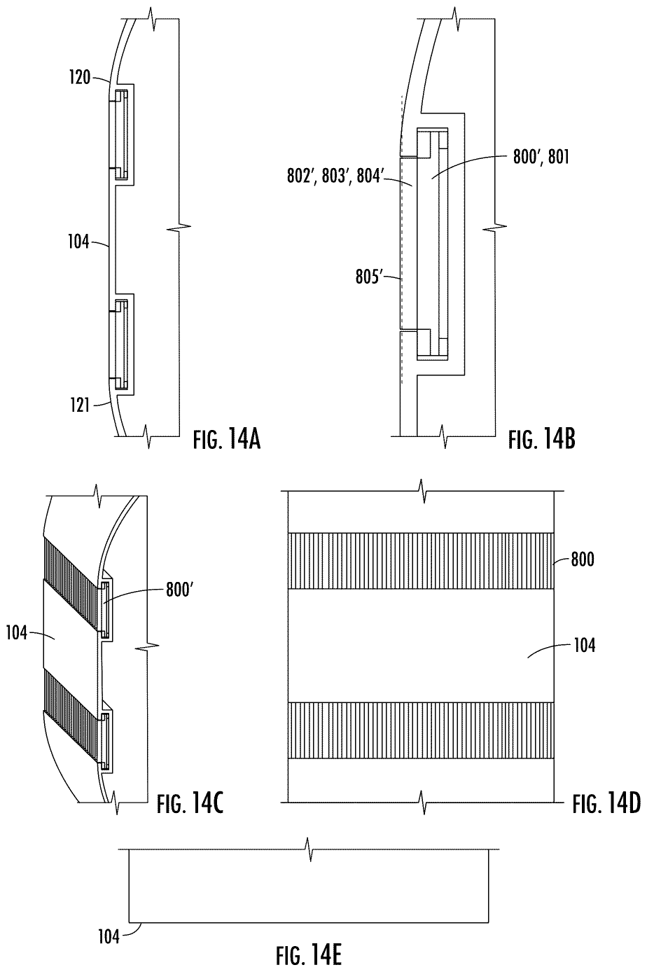

FIG. 14A to FIG. 14E show a variant of an antenna housing 101 of a base station antenna 100 according to the eighth example. The only difference from the antenna housing 101 shown in FIG. 13A to FIG. 13I is that the toothed part 803′ of the profile structure 802′ connected to the insertion part 801′ of the T-shaped insert 800′ does not extend outwards beyond the T-shaped groove 830′ or the first side surface 104. Each toothed part 803′ has two sloped surfaces 804′ that extend inclined to the first side surface 104, these two sloped surfaces 804′ intersect at the top edge 805', the top edge 805′ of the toothed part 803′ does not exceed beyond the first side surface 104 (see, in particular, FIG. 14B and FIG. 14E). Referring to FIG. 14B, the top edge 805′ is flush with the first side surface 104.

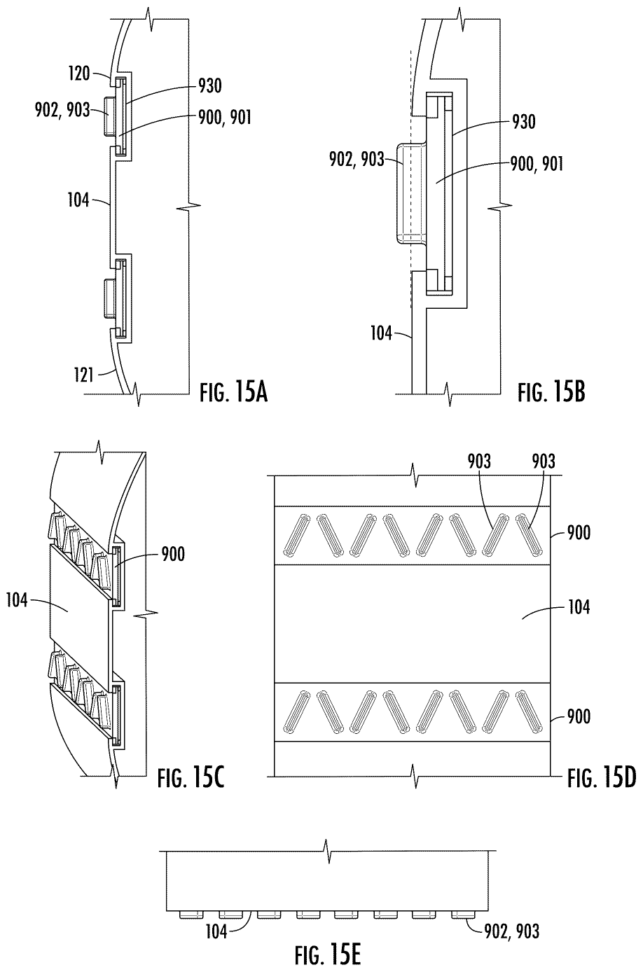

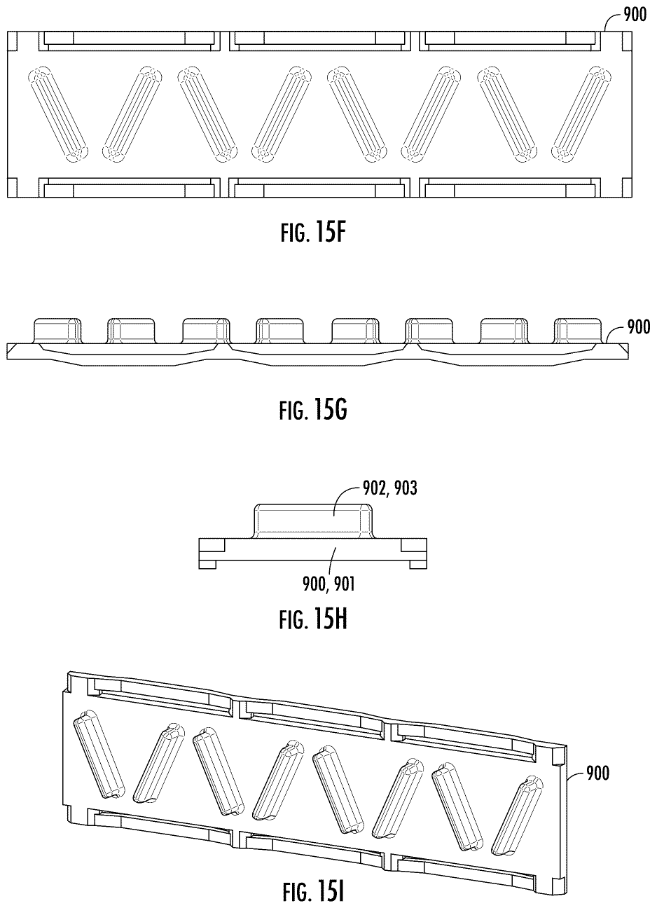

FIG. 15A to FIG. 15I show an antenna housing 101 of a base station antenna 100 according to a ninth example of embodiments of the present invention. Different from the above examples, the profile structure 902 on the insertion part 901 of the T-shaped insert 900 in the ninth example is designed differently. The profile structure 902 has a plurality of ribs 903 arranged successively, and each rib 903 extends inclined to the height direction L of the antenna housing 101. Referring to FIG. 15D, adjacent ribs 903 are adjacent end to end, and thus form a generally V-shaped arrangement structure. Referring to FIG. 15E, each rib 903 here at least partially extends beyond the T-shaped groove 930 or, in other words, the first side surface 104. The arrangement structure of the ribs 903 can be seen to reduce the peak wind load in the omnidirectional wind load distribution. Other aspects of the antenna housing 101 of the base station antenna 100 according to the ninth example adaptively refer to the design or variant of the antenna housing 101 according to the above examples and are not repeated here.

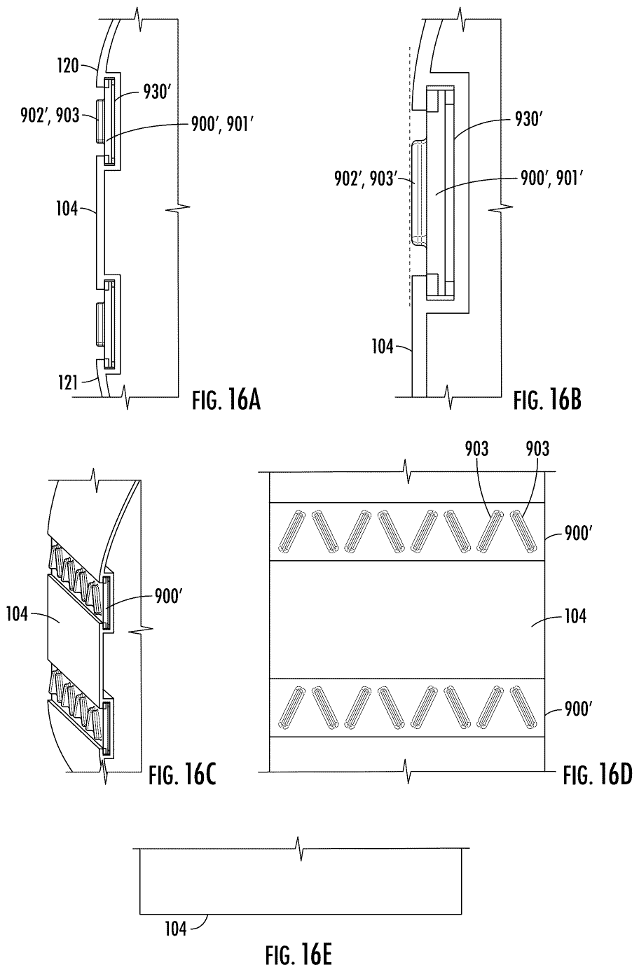

FIG. 16A to FIG. 16E show a variant of the antenna housing 101 of the base station antenna 100 according to the ninth example. The only difference from the antenna housing 101 shown in FIG. 15A to FIG. 15I is that the ribs 903′ of the profile structure 902′ connected to the insertion part 901′ of the T-shaped insert 900′ does not extend outwards beyond the T-shaped groove 930′ or the first side surface 104 (see, in particular, FIG. 16E). Referring to FIG. 16B, the upper top edges of the ribs 903′ are flush with the first side surface 104.

It is also conceivable that any combination of side profile features provided by the above examples or variants thereof may be provided on the first side surface 104 and/or the second side surface 106 of the same antenna housing 101.

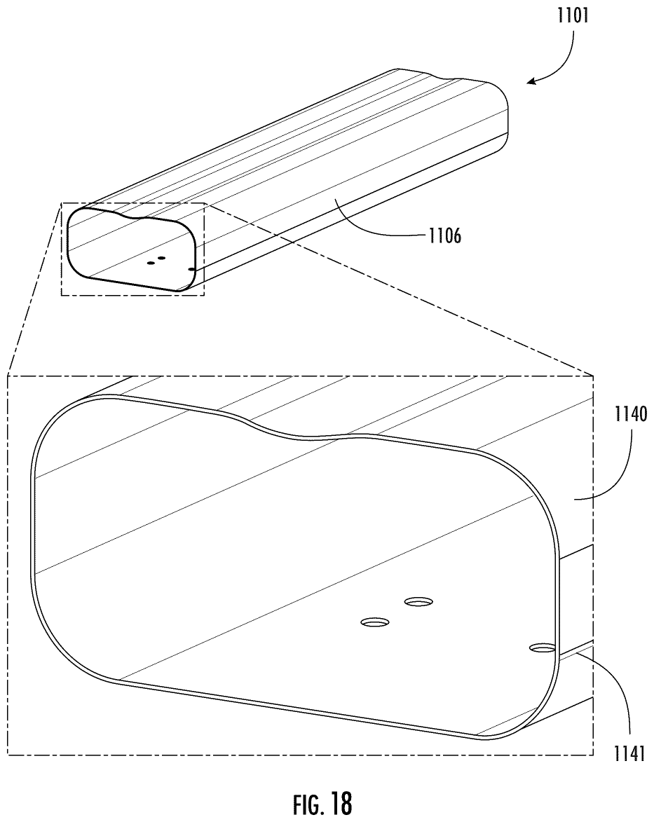

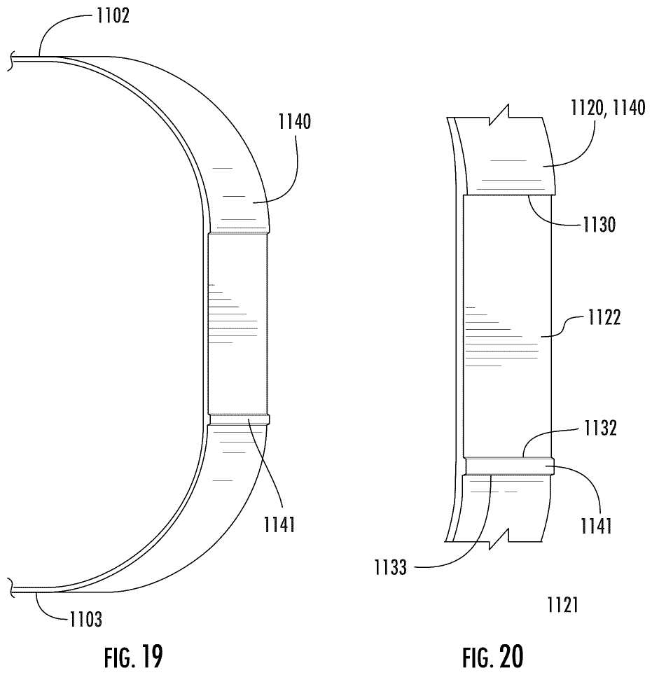

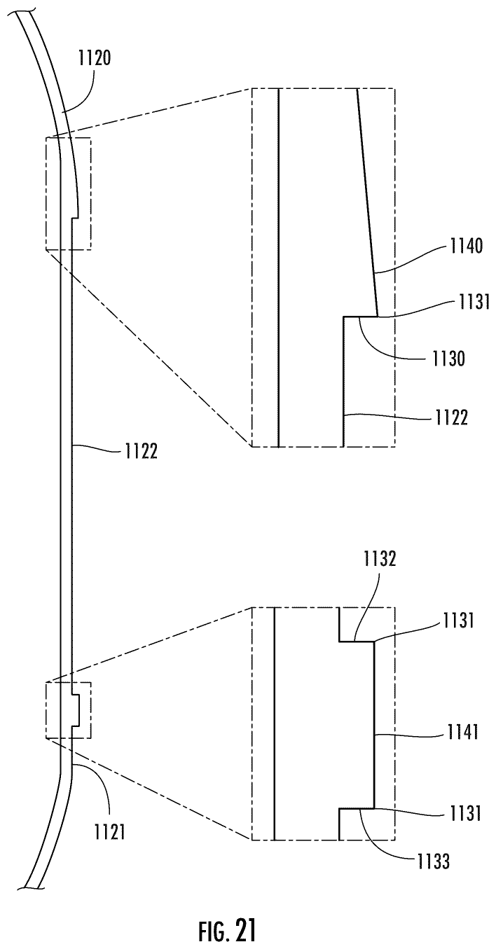

Referring to FIG. 18 to FIG. 21, an antenna radome 1101 of a base station antenna 1100 for reducing wind loads according to a first example of the present utility model is shown. A combination of side profile features provided for reducing the wind loads are provided on the second side surface 1106 of the exemplary visible antenna radome 1101 here. Referring particularly to FIGS. 19 to 21, the composite side profile character may include a step disposed on the front section 1120 of the second side surface 1106 near the corner to the front surface 1102. This step has a first stepped rising surface 1130 as the first side profile character or a part thereof. In the omnidirectional wind load distribution, this first stepped rising surface 1130 can influence the wind load peak in the range between 100° and 140° (e.g., near 110°). The first stepped rising surface 1130 may be oriented away from the front surface 1102. Therefore, the first stepped rising surface 1130 may be formed by a first protruding structure 1140 projecting from the second side surface 1106 or its middle section 1122 in front of it, specifically by the transition surface where the first protruding structure 1140 transitions to the middle section 1122. The first protruding structure 1140 may be configured as a material thickening of the radome 1101 itself, or it may also be conceivable to form it by a separate attachment fixed, for example by bonding, to the second side surface 1106, or by a combination of both. In other embodiments not shown, the first protruding structure 1140 may be formed by a lateral inward offset of wall sections of the radome 1101, where the thickness of the mutually offset wall sections may remain unchanged. The outer surface of the first protruding structure 1140 may here be formed as an inclined surface (see FIG. 21), or the first protruding structure 1140 may gradually thicken from front to back towards the stepped rising surface. The outer surface of the first protruding structure 1140 intersects the first stepped rising surface 1130 at the top edge 1131 of the first stepped rising surface 1130. Experimental verification has shown that the first stepped rising surface 1130 and its top edge 1131 have a significant effect on reducing wind load. Referring to FIG. 17, the first stepped rising surface 1130 and its top edge 1131 on the second side surface 1106 can significantly reduce the wind load peak in the range between 100° and 140° (e.g., near 110°) in the omnidirectional wind load distribution of the base station antenna 1100 (reduced from the red line to the black line).

The composite side profile character on the second side surface 1106 may further include two opposing steps disposed on the rear section 1121 of the second side surface 1106 near the corner to the rear surface 1103. They form two opposing stepped rising surfaces 1132, 1133 as the second side profile character or a part thereof, namely, a second stepped rising surface 1132 oriented towards the front surface 1102 and a third stepped rising surface 1133 oriented towards the rear surface 1103. The second and third stepped rising surfaces 1132, 1133 may be realized by the same second protruding structure 1141 projecting laterally from the second side surface 1106 or its middle section 1122. The second protruding structure 1141 may here be configured as an elongated rib. Here, the second stepped rising surface 1132 may be formed by the transition surface of the rib to the middle section 1122, while the third stepped rising surface 1133 may be formed by the transition surface of the rib to the rear section 1121. The rib may be configured as a material thickening of the radome 1101 itself, or it may also be conceivable to form it by a separate attachment fixed, for example by bonding, to the second side surface 1106, or by a combination of both. Similarly, the outer surface of the rib intersects the second and third stepped rising surfaces 1132, 1133 at the top edges 1131 of the second and third stepped rising surfaces 1132, 1133. Experimental verification has shown that the second and third stepped rising surfaces 1132, 1133 and their top edges 1131 have a significant effect on reducing wind load. Referring to FIG. 17, the second and third stepped rising surfaces 1132, 1133 and their top edges 1131 on the second side surface 1106 can significantly reduce the wind load peak in the range between 30° and 70° (e.g., near 50°) in the omnidirectional wind load distribution of the base station antenna 1100 (reduced from the red line to the black line).

In some embodiments, the first protruding structure 1140 and/or the second protruding structure 1141, and thus the first, second, and/or third stepped rising surfaces 1130, 1132, 1133, may extend continuously over the entire length L of the radome 1101. In some embodiments, the first protruding structure 1140 and/or the second protruding structure 1141, and thus the first, second, and/or third stepped rising surfaces 1130, 1132, 1133, may extend continuously over a partial length of the radome 1101. In some embodiments, the first protruding structure 1140 and/or the second protruding structure 1141, and thus the first, second, and/or third stepped rising surfaces 1130, 1132, 1133, may extend discontinuously over the entire length L or a partial length of the radome 1101, that is, multiple first protruding structures 1140 and/or second protruding structures 1141, and thus first, second, and/or third stepped rising surfaces 1130, 1132, 1133, may be arranged successively in the length direction.

In some embodiments, the height of the first, second, and/or third stepped rising surfaces 1130, 1132, 1133 may be between 0.5 mm and 4 mm. In some embodiments, the width of the rib may be between 1 mm and 15 mm. It will be understood that the respective design parameters may be adjusted according to the actual application scene.

The first, second, and third stepped rising surfaces 1130, 1132, 1133 may here be formed planar perpendicular to the middle section 1122, i.e., they may extend parallel to the width direction of the radome 1101.

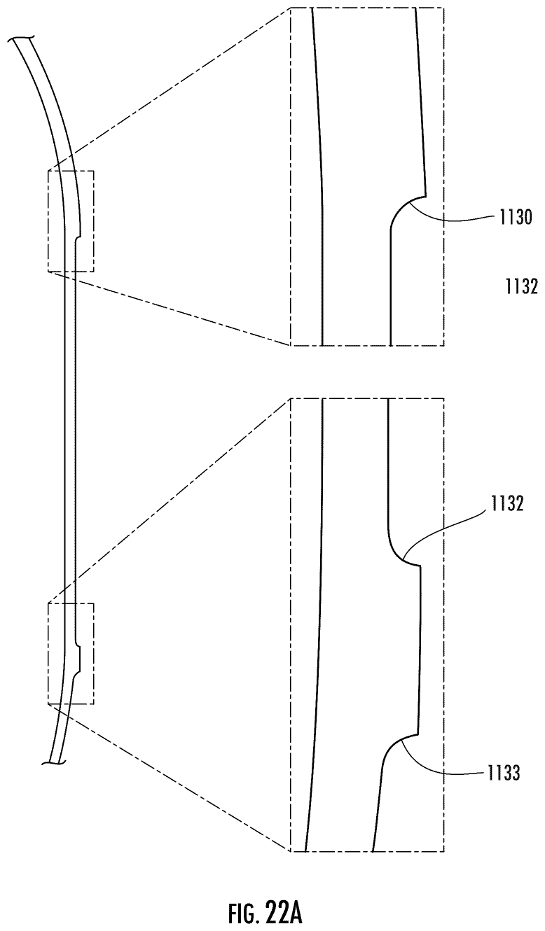

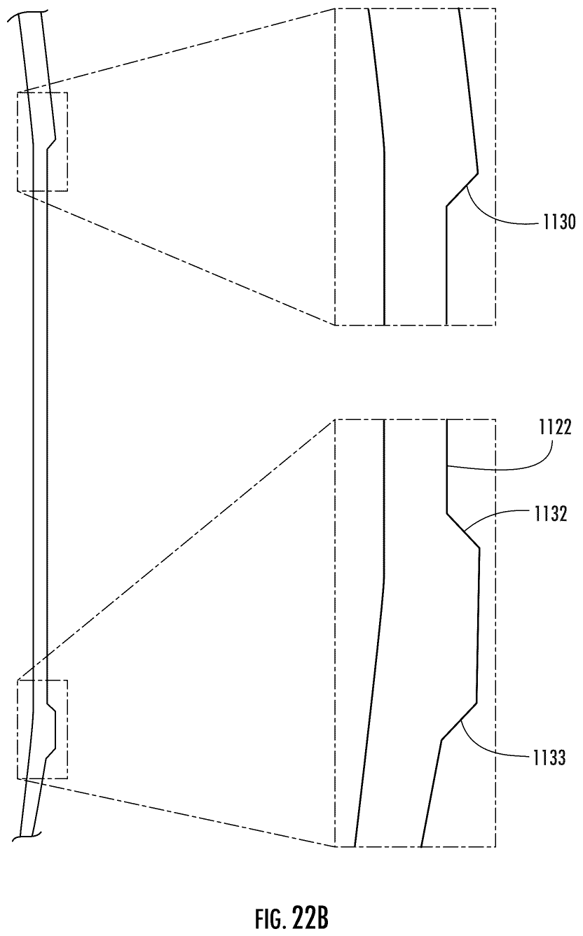

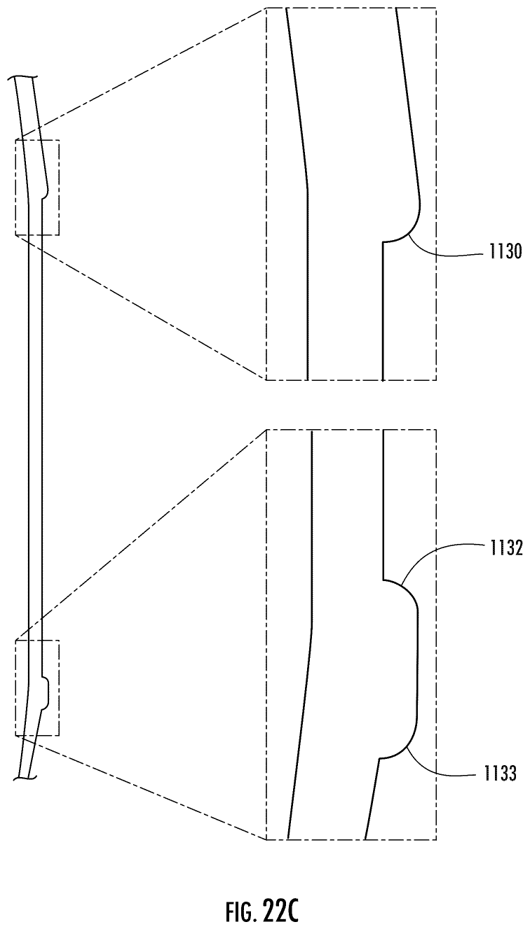

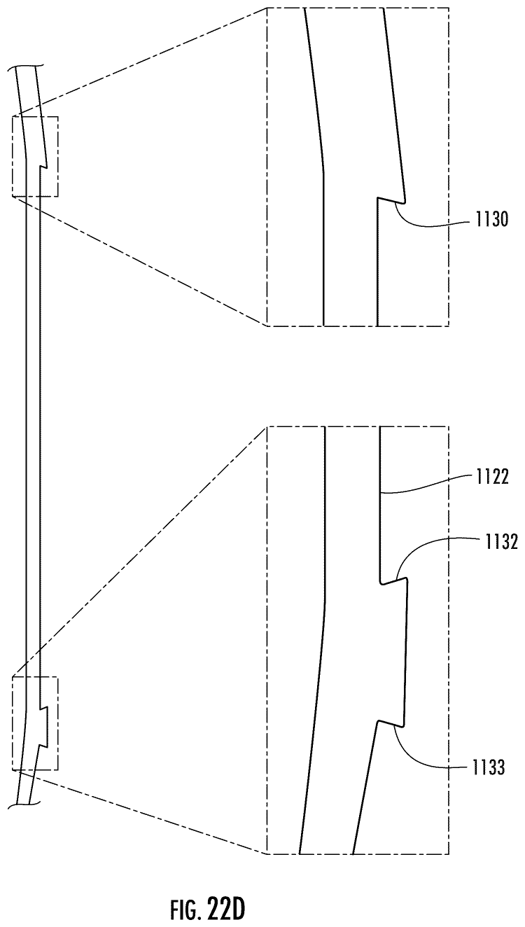

In a first variant of the first example shown in FIG. 22A, the first, second, and third stepped rising surfaces 1130, 1132, 1133 may be configured as concave arcs, while other structures may remain unchanged.

In a second variant of the first embodiment shown in FIG. 22B, the first, second, and third stepped rising surfaces 1130, 1132, 1133 may be formed inclined relative to the middle section 1122 and may form an obtuse angle with the second side surface 1106, while other structures may remain unchanged.

In a third variant of the first embodiment shown in FIG. 22C, the first, second, and third stepped rising surfaces 1130, 1132, 1133 may be configured as convex arcs, while other structures may remain unchanged.

In the fourth variant of the first example shown in FIG. 22D, the first, second, and third stepped rising surfaces 1130, 1132, 1133 may be configured to be inclined relative to the middle section 1122 and may form an acute angle with the second side surface 1106, while other structures may remain unchanged.

In some embodiments, the first, second, and third stepped rising surfaces 1130, 1132, 1133 may be any combination of all the shapes described above.

In some embodiments, the first protruding structure 1140 and the second protruding structure 1141 on the second side surface 1106 may be interchanged, or swapped in a mirror-symmetric manner.

Furthermore, the composite side profile character on the first side surface 1104 may be configured with reference to the composite side profile character on the second side surface 1106 to reduce wind load peaks within the ranges of 220° to 260° (e.g., near 250°) and 290° to 330° (e.g., near 300°) (reduced from the level indicated by the red line to that indicated by the black line). In some embodiments, the composite side profile character on the first side surface 1104 may be designed to be symmetric with the composite side profile character on the second side surface 1106 about a longitudinal section parallel to the side surfaces. In some embodiments, the first side surface 1104 and the second side surface 1106 may be arranged oppositely in terms of the positions of the first protruding structure 1140 and the second protruding structure 1141.

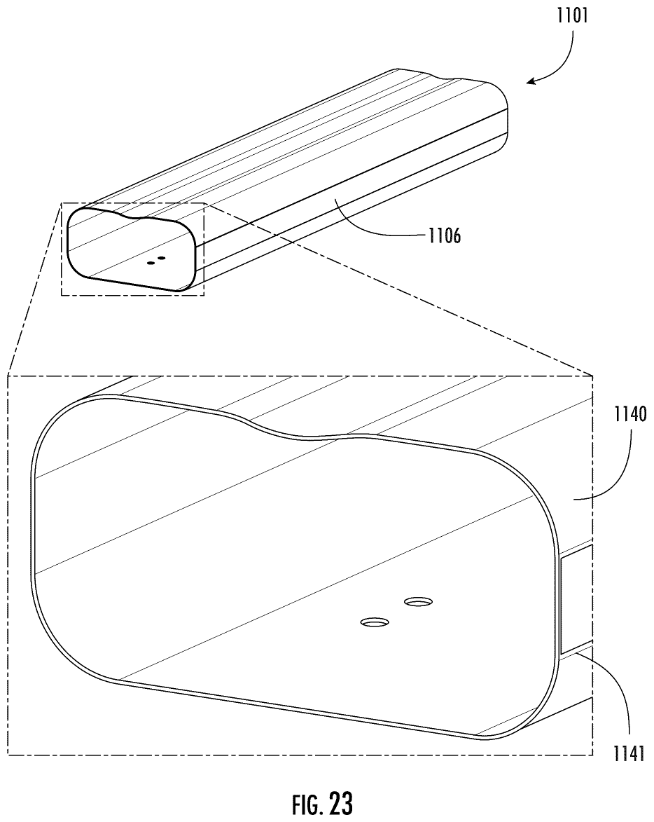

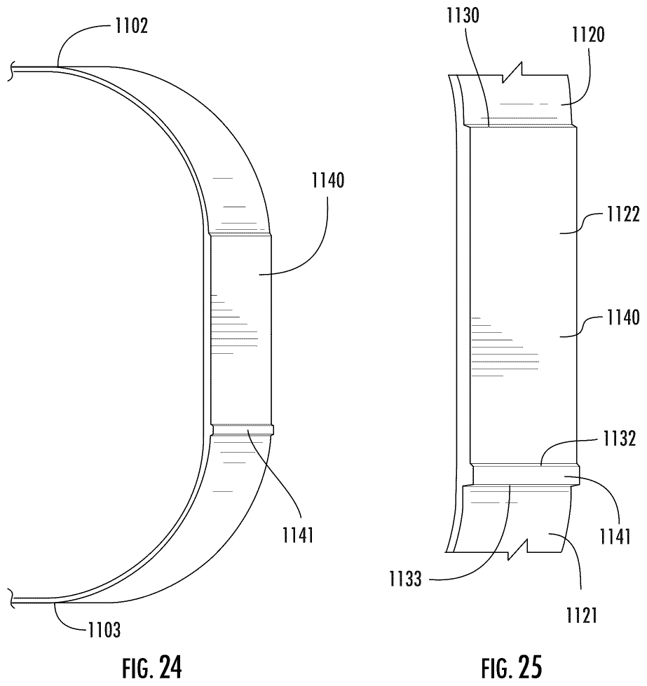

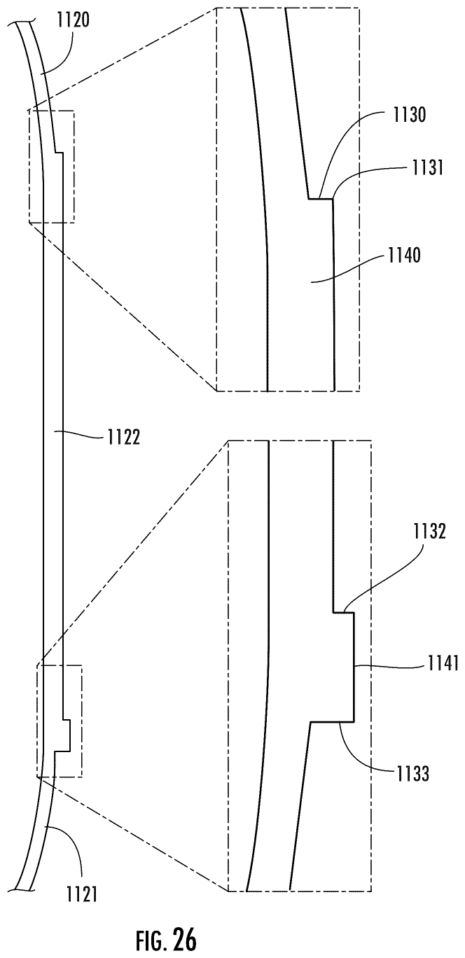

Referring to FIG. 23 to FIG. 26, an antenna radome 1101 of a base station antenna 1100 for reducing wind loads according to a second example of the present utility model is shown. A combination of side profile features provided for reducing the wind loads are provided on the second side surface 1106 of the exemplary visible antenna radome 1101 here. Referring particularly to FIG. 24 and FIG. 25, the composite side profile character may include a step disposed on the front section 1120 of the second side surface 1106 near the corner to the front surface 1102. This step has a first stepped rising surface 1130 as the first side profile character or a part thereof. In the omnidirectional wind load distribution, this first stepped rising surface 1130 can influence the wind load peak in the range between 100° and 140° (e.g., near 110°). The first stepped rising surface 1130 may be oriented towards the front surface 1102. Therefore, the first stepped rising surface 1130 may be formed by a first protruding structure 1140 that projects from the second side surface 1106, specifically from its front section 1120, behind it. More specifically, it is formed by the transition surface where the first protruding structure 1140 transitions to the front section 1120. The first protruding structure 1140 may extend through the entire middle section 1122. The first protruding structure 1140 may be configured as a material thickening of the radome 1101 itself, or it may also be conceivable to form it by a separate attachment fixed, for example by bonding, to the second side surface 1106, or by a combination of both. In other embodiments not shown, the first protruding structure 1140 may be formed by a lateral outward offset of wall sections of the radome 1101, where the thickness of the mutually offset wall sections may remain unchanged. The outer surface of the first protruding structure 1140 intersects the first stepped rising surface 1130 at the top edge 1131 of the first stepped rising surface 1130. Experimental verification has shown that the first stepped rising surface 1130 and its top edge 1131 have a significant effect on reducing wind load. Referring to FIG. 17, the first stepped rising surface 1130 and its top edge 1131 on the second side surface 1106 can significantly reduce the wind load peak in the range between 100° and 140° (e.g., near 110°) in the omnidirectional wind load distribution of the base station antenna 1100 (reduced from the red line to the black line).

The composite side profile character on the second side surface 1106 may further include two opposing steps disposed on the rear section 1121 of the second side surface 1106 near the corner to the rear surface 1103. They form two opposing stepped rising surfaces 1132, 1133 as the second side profile character or a part thereof, namely, a second stepped rising surface 1132 oriented towards the front surface 1102 and a third stepped rising surface 1133 oriented towards the rear surface 1103. The second and third stepped rising surfaces 1132, 1133 may be realized by the same second protruding structure 1141 projecting laterally from the middle section 1122. The second protruding structure 1141 may be adjacent to the first protruding structure 1140 and project laterally beyond the first protruding structure 1140. In other words, the second protruding structure 1141 may be arranged adjacent to and stacked upon the first protruding structure 1140. The rear surfaces of the second protruding structure 1141 and the first protruding structure 1140 may be flush with each other. While the width of the second protruding structure 1141 may be smaller than that of the first protruding structure 1140, the second protruding structure 1141 may be configured as an elongated rib. Here, the second stepped rising surface 1132 may be formed by the transition surface from the rib to the middle section 1122, or to the first protruding structure 1140, while the third stepped rising surface 1133 may be formed by the transition surface from the rib to the rear section 1121. In other words, the second stepped rising surface 1132 may be formed by the front side surface of the second protruding structure 1141 (i.e., the rib), while the third stepped rising surface 1133 may be jointly formed by the rear side surfaces of the first protruding structure 1140 and the second protruding structure 1141 (i.e., the rib). Therefore, the height of the second stepped rising surface 1132 may be less than the height of the third stepped rising surface 1133. The rib may be configured as a material thickening of the radome 1101 itself, or it may also be conceivable to form it by a separate attachment fixed, for example by bonding, to the second side surface 1106, or by a combination of both. Similarly, the outer surface of the rib may intersect the second and third stepped rising surfaces 1132, 1133 at the top edges 1131 of the second and third stepped rising surfaces 1132, 1133. Experimental verification has shown that the second and third stepped rising surfaces 1132, 1133 and their top edges 1131 on the second side surface 1106 have a significant effect on reducing wind load. Referring to FIG. 13, in the omnidirectional wind load distribution of the base station antenna 1100, the second and third stepped rising surfaces 1132, 1133 and their top edges 1131 can significantly reduce wind load peaks within the range of 30° to 70° (e.g., near 50°) (reduced from the level indicated by the red line to that indicated by the black line).

In some embodiments, the first protruding structure 1140 and/or the second protruding structure 1141, and thus the first, second, and/or third stepped rising surfaces 1130, 1132, 1133, may extend continuously over the entire length L of the radome 1101. In some embodiments, the first protruding structure 1140 and/or the second protruding structure 1141, and thus the first, second, and/or third stepped rising surfaces 1130, 1132, 1133, may extend continuously over a partial length of the radome 1101. In some embodiments, the first protruding structure 1140 and/or the second protruding structure 1141, and thus the first, second, and/or third stepped rising surfaces 1130, 1132, 1133, may extend discontinuously over the entire length L or a partial length of the radome 1101, that is, multiple first protruding structures 1140 and/or second protruding structures 1141, and thus first, second, and/or third stepped rising surfaces 1130, 1132, 1133, may be arranged successively in the length direction.

In some embodiments, the height of the first, second, and/or third stepped rising surfaces 1130, 1132, 1133 may be between 0.5 mm and 4 mm. In some embodiments, the width of the rib may be between 1 mm and 15 mm. It will be understood that the respective design parameters may be adjusted according to the actual application scene.

The first, second, and third stepped rising surfaces 1130, 1132, 1133 may here be formed planar perpendicular to the middle section 1122, i.e., they may extend parallel to the width direction of the radome 1101.

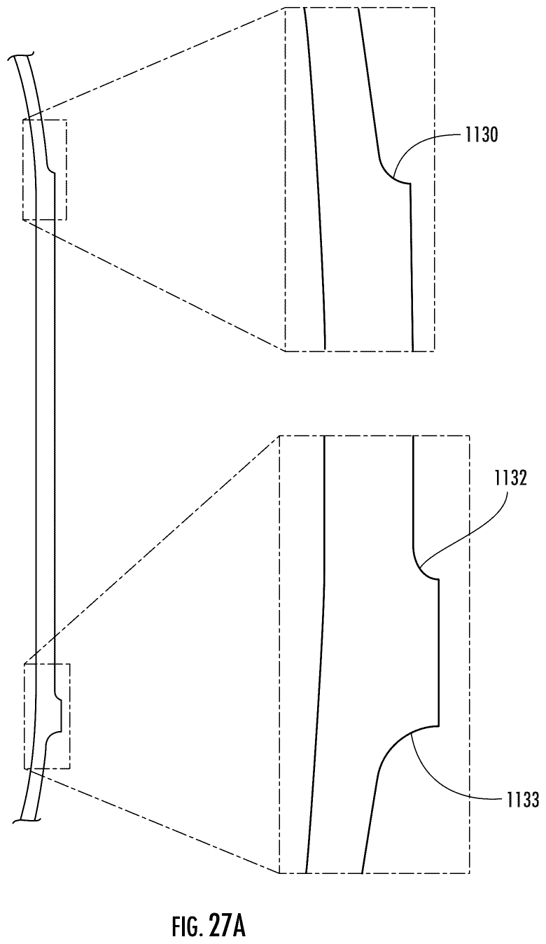

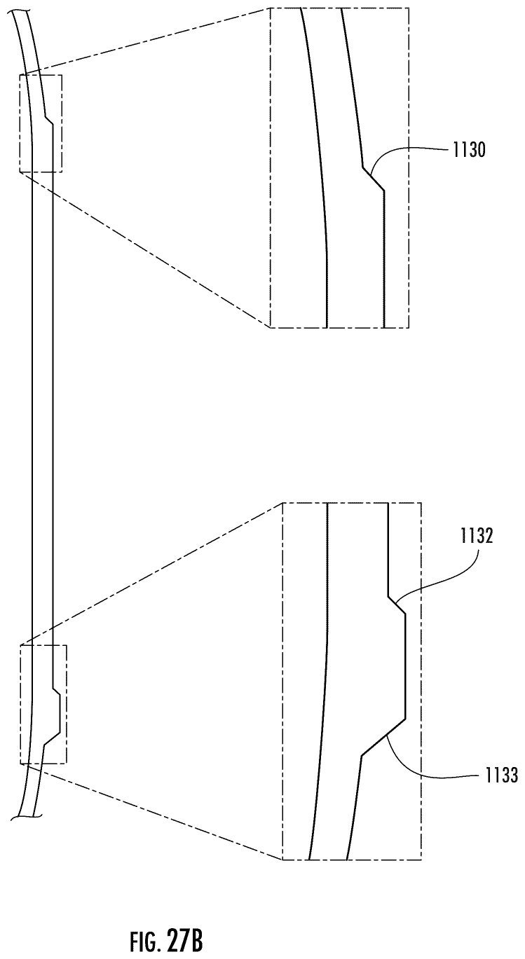

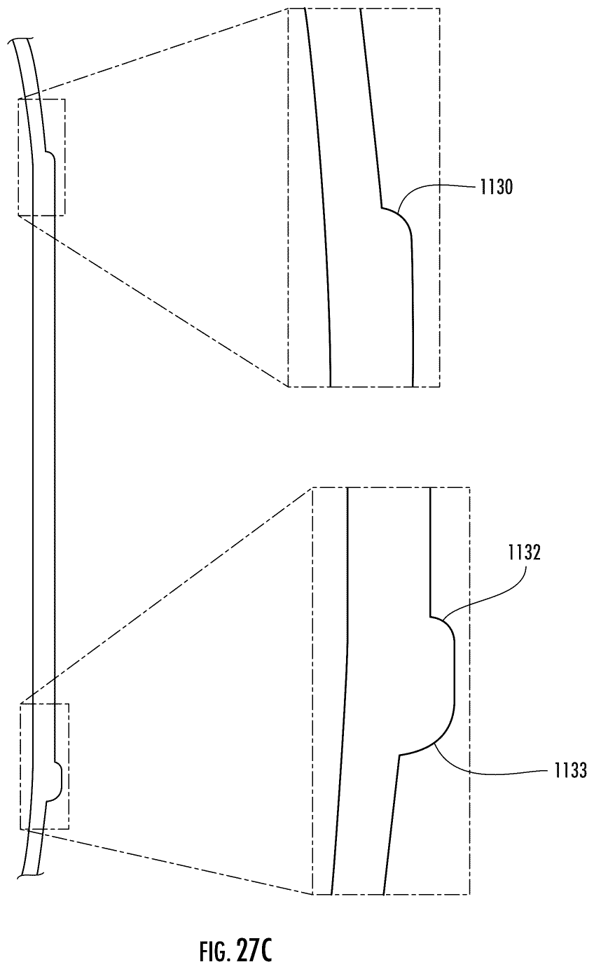

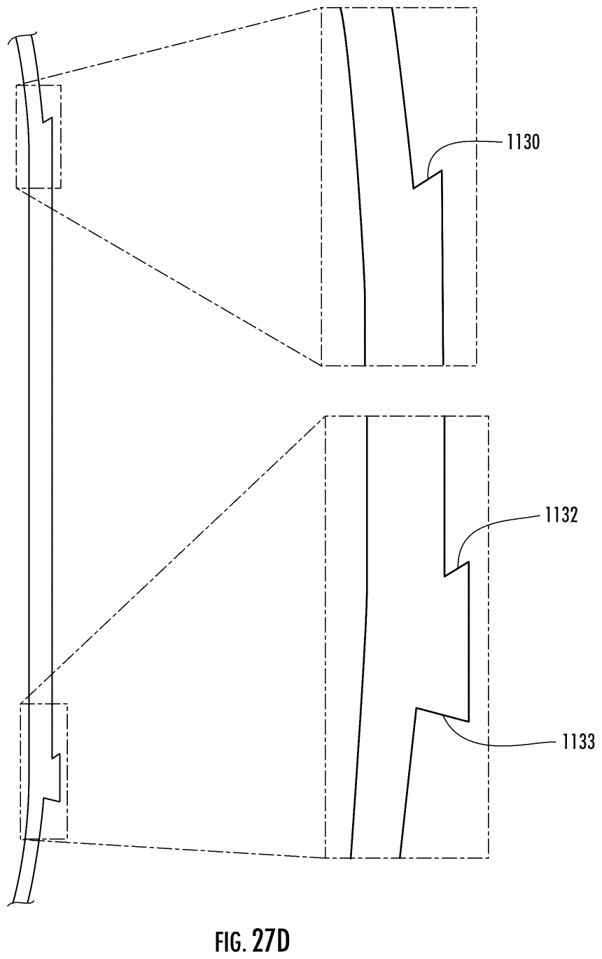

In a first variant of the first example shown in FIG. 27A, the first, second, and third stepped rising surfaces 1130, 1132, 1133 may be configured as concave arcs, while other structures may remain unchanged.

In a second variant of the first example shown in FIG. 27B, the first, second, and third stepped rising surfaces 1130, 1132, 1133 may be formed inclined relative to the middle section 1122 and may form an obtuse angle with the second side surface 1106, while other structures may remain unchanged.

In a third variant of the first example shown in FIG. 27C, the first, second, and third stepped rising surfaces 1130, 1132, 1133 may be configured as convex arcs, while other structures may remain unchanged.

In the fourth variant of the first example shown in FIG. 27D, the first, second, and third stepped rising surfaces 1130, 1132, 1133 may be configured to be inclined relative to the middle section 1122 and may form an acute angle with the second side surface 1106, while other structures may remain unchanged.

Similarly, for the second example, in some embodiments, the first, second, and third stepped rising surfaces 1130, 1132, 1133 may be any combination of all the shapes described above.

In some implementations, the first protruding structure 1140 and the second protruding structure 1141 on the second side surface 1106 may be interchanged, or swapped in a mirror-symmetric manner.

Furthermore, the composite side profile character on the first side surface 1104 may be configured with reference to the composite side profile character on the second side surface 1106 to reduce wind load peaks within the ranges of 220° to 260° (e.g., near 250°) and 290° to 330° (e.g., near 300°) (reduced from the level indicated by the red line to that indicated by the black line). In some implementations, the composite side profile character on the first side surface 1104 may be designed to be symmetric with the composite side profile character on the second side surface 1106 about a longitudinal section parallel to the side surfaces. In some implementations, the first side surface 1104 and the second side surface 1106 may be arranged oppositely in terms of the positions of the first protruding structure 1140 and the second protruding structure 1141.

Additionally, it is conceivable to arrange any combination of the side profile characters specified by the first example or its variants and the second example or its variants on the first side surface 1104 and the second side surface 1106, respectively, of the same antenna radome 1101.

Embodiments of the present invention may include any feature or combination of features or its summarization disclosed herein implicitly or explicitly, not limited to any defined range listed above. Any element, feature, and/or structural arrangement described herein may be combined in any suitable manner.

The specific examples disclosed above are merely exemplary, and it is apparent to those skilled in the art benefiting from the teachings herein that embodiments of the present invention can be modified and implemented in different but equivalent ways. Therefore, it is clear that changes and modifications can be made to the specific examples disclosed above, and all such variants are considered to fall within the scope and spirit of embodiments of the present invention.

What is claimed is:

1. An antenna housing for a base station antenna, characterized in that the antenna housing has a front surface and a rear surface that are opposite and a first side surface and a second side surface that are opposite, which are connected to form an enclosing antenna housing,
wherein at least one side surface of the first side surface and the second side surface has at least one side profile feature for reducing wind loads, wherein the side profile feature comprises at least one groove extending in a height direction of the antenna housing, the groove is opened towards an outer side of the at least one side surface in a width direction of the antenna housing, the groove is provided with at least one side recess at its side direction, and the side recess is opened towards an interior of the groove in a thickness direction of the antenna housing.

2. The antenna housing for a base station antenna according to claim 1, characterized in that the groove comprises at least one of a dovetail groove and a T-shaped groove.

3. The antenna housing for a base station antenna according to claim 1, characterized in that the groove has two step surfaces towards each other at its opening, and the two step surfaces are aligned with or staggered from each other in a width direction of the antenna housing.

4. The antenna housing for a base station antenna according to claim 1, characterized in that the side profile feature further comprises at least one insert that can be fixed in the groove, the insert has an insertion part and a profile structure for reducing wind loads connected to the insertion part, and the insert is capable of being inserted into the groove with its insertion part in a form locking mode.

5. The antenna housing for a base station antenna according to claim 4, characterized in that the profile structure of the insert is flush with the at least one side surface or at least partially extends beyond the at least one side surface.

6. The antenna housing for a base station antenna according to claim 4, characterized in that the insert comprises a truncated sphere formed as its profile structure and at least one support leg formed as its insertion part, and the truncated sphere has a bottom surface towards the at least one side surface and a truncated sphere surface away from the at least one side surface.

7. The antenna housing for a base station antenna according to claim 4, characterized in that the profile structure of the insert comprises a plurality of columns and/or ribs arranged successively in a height direction of the antenna housing.

8. The antenna housing for a base station antenna according to claim 4, characterized in that the profile structure of the insert comprises at least one toothed part, and the toothed part extends parallel to, perpendicular to, or inclined to the height direction of the antenna housing.

9. The antenna housing for a base station antenna according to claim 4, characterized in that a plurality of inserts are arranged successively in the groove.

10. The antenna housing for a base station antenna according to claim 1, characterized in that the side profile features are provided on a front side part and/or a rear side part of the at least one side surface.

11. A base station antenna, characterized in that the base station antenna has an antenna housing for a base station antenna according to claim 1, the antenna housing being covered by a top end cover and a bottom end cover at both ends.

12. An antenna radome for a base station antenna, characterized in that the radome has opposing front and rear surfaces and opposing first and second side surfaces, which are connected to form a surrounding radome; the first side surface and the second side surface each comprise a middle section, a front section disposed on the front side of the middle section, and a rear section disposed on the rear side of the middle section,
wherein, at least one of the first and second side surfaces has a composite side profile character for reducing wind load, the composite side profile character comprising a first side profile character disposed on the front section and a second side profile character disposed on the rear section, wherein the first side profile character and the second side profile character differ from each other.

13. The antenna radome for a base station antenna according to claim 12, characterized in that the first side profile character has a first number of stepped rising surfaces, and the second side profile character comprises a second number of stepped rising surfaces different from the first number, each stepped rising surface being disposed transversely on the at least one side surface.

14. The antenna radome for a base station antenna according to claim 13, characterized in that the stepped rising surfaces are each formed by protruding structures projecting from the at least one side surface, the protruding structures being formed by a thickened portion of the radome wall and/or by mutually offset wall sections of the radome and/or by attachments affixed to the radome wall.

15. The antenna radome for a base station antenna according to claim 13, characterized in that one of the first and second side profile characters has a first stepped rising surface, while the other side profile character has a second stepped rising surface and a third stepped rising surface.

16. The antenna radome for a base station antenna according to claim 15, characterized in that the first stepped rising surface is disposed facing toward or away from the middle section, and the second and third stepped rising surfaces are disposed oppositely.

17. The antenna radome for a base station antenna according to claim 15, characterized in that the first stepped rising surface is formed by a first protruding structure extending away from the middle section, and the second and third stepped rising surfaces are formed by two opposing sides of a second protruding structure configured as ribs.

18. The antenna radome for a base station antenna according to claim 15, characterized in that the first stepped rising surface is formed by a first side of a first protruding structure extending through the middle section, one of the second and third stepped rising surfaces is formed by a first side of a second protruding structure configured as ribs, and the other of the second and third stepped rising surfaces is jointly formed by a second side of the first protruding structure and a second side of the second protruding structure.

19. The antenna radome for a base station antenna according to claim 13, characterized in that at least one stepped rising surface extends continuously or discontinuously over at least a partial length of the at least one side surface.

20. A base station antenna, characterized in that the base station antenna has an antenna radome for a base station antenna according to claim 12, the antenna radome being covered by a top end cover and a bottom end cover at both ends.
